(19) United States
(12) Patent Application Publication
(10) Pub. No.: US 2026/0340647 A1
(43) Pub. Date: Oct. 29, 2026

(54) RECALL INVESTIGATION FOR ANOMALIES BASED ON ANNUAL PRODUCT QUALITY REPORTS

(71) Applicant: Honeywell International Inc., Charlotte, NC (US)

(72) Inventors: Ankit Singh, Apex, NC (US); Waad Subber, Schenectady, NY (US); Sophie Basak Atilgan, West Windsor, NJ (US); Lakshminarayana Paila, Frisco, TX (US)

(21) Appl. No.: 19/190,813

(22) Filed: Apr. 28, 2025

(51) Int. Cl. G06Q 30/014; G06F 40/30; G06Q 10/0639

(52) U.S. Cl. CPC G06Q 30/014; G06F 40/30; G06Q 10/06395

(57) ABSTRACT

Example techniques for generation of a recall investigation report for a product are described. In an example, based on quality events data indicative of deviation in a predefined quality parameter of the product with respect to a predefined threshold, batches of the product with anomalies is identified. Further, one or more assessment parameters required for compiling the recall investigation report for assessing the deviation is defined. A PQR report is accessed from a database of a quality management system. Using a large language model (LLM), a chapter of the PQR report with content that has at least a preset degree of semantic similarity with the one or more assessment parameters is identified. A filter to the identified chapter is applied to extract content of the identified chapter corresponding to a batch of the product associated with the deviation. The recall investigation report is populated based on the extracted content.

### BACKGROUND

A wide variety of products, such as medical devices, pharmaceuticals items, consumables, automotive items, toys, food products, various types of equipment, or the like, are manufactured for consumer markets. Since these products are designed for use by various individuals and for various purposes, these products are required to meet certain safety standards that may be prescribed by regulatory authorities. For example, a pharmaceutical product, such as a pain reliever or an antibiotic, may be required to adhere to stringent quality and safety standards set by health regulatory agencies. The manufacturing process of such products typically involves several stages, including, but not limited to, production, testing, and post-manufacturing activities such as packaging and distribution. To ensure that each stage of the manufacturing process meets predefined quality standards, each stage follows standard operating procedures (SOPs). Following the SOPs defined for each stage of the manufacturing process of the products may help ensure product quality, consistency, and compliance with regulatory requirements.

Despite precautions, the products may sometimes be found unsafe after reaching end consumers. Safety concerns may arise from anomalies in the products that may be attributed to design flaws, production errors, or the use of harmful substances in the manufacturing of the products. For example, a medicine may contain an incorrect dosage of an active ingredient, posing significant health risks to patients. Additionally, the products that initially met the regulatory requirements may become non-compliant due to changes in regulations or newly discovered risks after they are made available in the market for use by the end consumers. For example, a food product may be found to contain an ingredient newly classified as harmful. In such cases, manufacturers of such products may need to take corrective actions to ensure safety of the consumers and compliance with updated regulatory requirements. These corrective actions often include voluntary recalls of the products identified as unsafe or non-compliant, along with communication to consumers and stakeholders to mitigate risks effectively.

The process of recalling the products may be complex, involving various activities such as communication with stakeholders, coordination of returns of the products, dissemination of information, and providing support to the consumers. The financial and operational costs associated with the recalls may be significant, encompassing recall execution, refunds, and compensation. Additionally, the decision to recall the products may affect the reputation of a manufacturer and consumer trust. Therefore, it is crucial to manage the recalls in accordance with predefined processes that comply with the regulatory requirements while optimizing other aspects of the recall process, such as communication strategies, logistics, and consumer relations.

Nowadays, to effectively manage the recall process, the manufacturers of products use product recall management systems (PRMSs). A PRMS may assist the manufacturers in investigating factors that influence the recall decisions, managing the recall process efficiently, streamlining communication with the stakeholders, and ensuring compliance with the regulatory requirements.

### SUMMARY

The details of some embodiments of the invention described in this specification are set forth in the accompanying drawings and the description below. Other features, aspects, and advantages of the invention will become apparent from the description, the drawings, and the claims.

The present subject matter relates to methods, systems, and non-transitory computer-readable media for generating a recall investigation report of a product based on content included in chapters of a product quality review (PQR) report.

In accordance with an embodiment of the present subject matter, a product recall management system (PRMS) is used to generated the recall investigation report. In an embodiment, data corresponding to quality events reported in respect of a product is received at the PRMS. The quality events data is indicative of deviation in at least one predefined quality parameter of the product with respect to a predefined threshold. Further, one or more assessment parameters for compiling the recall investigation report for assessing the deviation is defined in the PRMS. Furthermore, the PRMS accesses, from a database, a product quality review (PQR) report of the product. The PQR report includes chapters. Each chapter corresponds to one of the predefined quality parameters of a plurality of batches of the product and includes content related to that quality parameter. The PRMS identifies, using a large language model (LLM), a chapter of the PQR report with content that has at least a preset degree of semantic similarity with the one or more assessment parameters. The PRMS further applies a filter to the identified chapter to extract content of the identified chapter corresponding to a batch of the product associated with the deviation. The PRMS populates the recall investigation report based on the extracted content.

In accordance with another aspect of the present invention, the method is implemented in a product recall management system (PRMS) that manages workflows for generating the recall investigation report. The method includes identifying a deviation in at least one predefined quality parameter of the product with respect to a predefined threshold. The method further includes defining one or more assessment parameters for compiling the recall investigation report for assessing the deviation. Furthermore, the method includes accessing, from a database of a quality management system (QMS), a product quality review (PQR) report of the product. The PQR includes chapters. Each chapter of the PQR report corresponds to one of the predefined quality parameters of a plurality of batches of the product and include content related to that quality parameter. Furthermore, the method includes identifying, using a large language model (LLM), a chapter of the PQR report with content that has at least a preset degree of semantic similarity with the one or more assessment parameters. The method includes applying a filter to the content of the identified chapter to extract content corresponding to a batch of the product associated with the deviation. The method further includes populating the recall investigation report based on the extracted content to generate the recall investigation report.

In accordance with an embodiment of the present invention, the non-transitory computer-readable medium contains instructions that enable a processing resource to obtain quality events data in respect of a product. The quality events data is indicative of a deviation in at least one quality parameter of the product from a predefined threshold. The instructions are executable to obtain user input relating to the deviation. The user input is textual description of one or more assessment parameters required for compiling a recall investigation report for assessing the deviation. The instructions are further executable to access, from a database of a quality management system (QMS), a product quality review (PQR) of the product. The PQR report includes a plurality of chapters. Each chapter of the PQR report corresponds to one of the predefined quality parameters of a plurality of batches of the product and includes content related to that quality parameter. The instructions are executable to identify, using a large language model (LLM), a chapter of the PQR report with content that has at least a preset degree of semantic similarity with the user input. Furthermore, the instructions are executable to apply a filter to the identified chapter to extract content of the identified chapter corresponding to a batch of the product associated with the deviation. The instructions are executable to generate the recall investigation report based on the extracted content.

By extracting relevant content pertaining to the assessment parameters of the recall investigation report required for conducting the recall investigation from the PQR report, the present subject matter ensures significant time savings and reduction in duplicative efforts in generation of the recall investigation report. Accessing the content required for the recall investigation from the PQR report eliminates the need for manual searching and compilation of the content from multiple document management systems, drastically reducing the time required to initiate and complete recall investigations. This may lead to faster response times in addressing potential quality issues, ultimately enhancing product safety and regulatory compliance while significantly reducing the overall workload and resource allocation for recall investigations.

Additional features and advantages are realized through the concepts of the present invention, including improved recall management, reduced delays, and enhanced communication efficiency. Other embodiments and aspects of the invention are described in detail herein and are considered a part of the claimed invention.

### BRIEF DESCRIPTION OF FIGURES

The following detailed description references the drawings, wherein:

FIG. 1 illustrates a network environment for implementing example techniques for preparing recall investigation report of a product, in accordance with an example implementation of the present subject matter;

FIG. 2 illustrates a block diagram of a product recall management system (PRMS) for generating the recall investigation report for the product, in accordance with an example implementation of the present subject matter;

FIG. 3 illustrates the PRMS for generating the recall investigation report for the product, in accordance with another example implementation of the present subject matter;

FIG. 4 illustrates a signal flow in a process of generation of the recall investigation report, in accordance with an example implementation of the present subject matter;

FIG. 5 illustrates a method for generating a recall investigation report of a product, in accordance with an example implementation of the present subject matter;

FIG. 6 illustrates a flow diagram of a process for generating the recall investigation report for the product, in accordance with another example implementation of the present subject matter;

FIG. 7 illustrates a flow diagram of a process for identifying a relevant chapter from a plurality of chapters of a product quality review (PQR) report, in accordance with an example implementation of the present subject matter;

FIG. 8 illustrates a flow diagram of a process for generating a recall investigation request for batches of the product based on content of the chapters of the PQR report, in accordance with an example implementation of the present subject matter; and

FIG. 9 illustrates a computing environment for generating a recall investigation report for a product, in accordance with an example implementation of the present subject matter.

In the figures, the left-most digits of a reference number identify the figure in which the reference number first appears. The same numbers are used throughout the drawings to reference like features and components.

### DETAILED DESCRIPTION

A product or batches of the product may be subject to a recall by a manufacturer of the product for various reasons, such as identification of safety concerns or anomalies in the product that may harm consumers or expose the manufacturer to legal liability. Often, anomalies in the product result from deviations in one or more predefined quality parameters of the product with respect to a predefined threshold. For example, a pharmaceutical product may be recalled if the concentration of its active ingredient falls below or exceeds an acceptable threshold defined by regulatory standards, or a food product may be recalled if the level of a contaminant, such as a pesticide residue, surpasses the maximum allowable limit. Occasionally, recalls are initiated also due to changes in regulations, leading to non-compliance of products with new regulations although the products were compliant with previous regulations. The purpose of the recall may be to address these issues by withdrawing affected products from a market or by rectifying an identified anomaly.

Manufacturers rely on product recall management systems (PRMSs) to facilitate a recall process. The PRMSs are specialized tools designed to streamline the process of recalling the product or the batches of the product from the market. Typically, a PRMS includes two primary sub-systems: a recall decision sub-system and a recall execution sub-system. The recall decision sub-system is tasked with an initial phase of conducting investigations for deciding whether to initiate a recall for a product or batches of the product. In doing so, the recall decision sub-system employs workflows that provide means to collect data, conduct risk analyses, and support decision-making vis à vis the recall of the product. The recall execution sub-system, on the other hand, is configured to implement the execution of the recall once a decision has been made, providing the workflow and tools to do so.

When a complaint regarding an anomaly in a product or batches of the product is received, for example, from a consumer of the product, or through a system of the manufacturer that periodically collects quality events related data from various sources and identifies batches with anomaly, a user at the end of the manufacturer may issue a request for an generating a recall investigation report for such batches of the product through the recall decision sub-system.

The recall investigation report may include an investigation, often referred to as a recall investigation or risk investigation, to assess the validity, impact, and scope of deviations in the predefined quality parameters that resulted in an anomaly in the affected batches of the product, prompting the complaint regarding the product. The recall investigation may involve gathering inputs from users, vendors, and other stakeholders and analysing data, such as customer complaints, and safety concerns related to the reported anomaly, and data related to lifecycle of the product. The goal is to determine whether the anomaly poses a risk to consumers, if the anomaly warrants a recall of the product, and likely impact of the recall.

Based on the recall investigation report, if a decision to recall the batches of the product is made, in other words, a request for the recall of the batches of product is approved at the recall decision sub-system, a signal for execution of the recall of the identified batches of the product is sent to the recall execution sub-system that executes the workflows necessary for recalling the identified batches of the product from the market.

During the recall investigation, assessment parameters necessary for evaluating the deviation in the predefined quality parameters of the product are defined and included in the recall investigation report. The assessment parameters may be understood as specific criteria or metrics used to evaluate the deviations in the predefined quality parameters of the product. These assessment parameters help determine the extent, impact, and risks associated with the recall of the product with the anomalies. In an example, the assessment parameters may include, but are not limited to, quality impact investigation, risk impact investigation, health hazard investigation, compliance investigation, risk investigation, or the like.

Corresponding to each of these assessment parameters, content relevant to the batches of the product identified to have an anomaly is included, for example, for carrying out the recall investigation to assess deviation in the predefined quality parameters of the product. For example, for a product like a headache medicine, under the assessment parameter “quality impact investigation”, content that may be needed for carrying out the recall investigation may be those related to quality of the headache medicine. This may include content pertaining to product overview, quality control parameters relating to manufacturing conditions, quality parameters relating to procurement and storing of ingredients of the example product, i.e., headache medicine, in the present case. Similarly, for the assessment parameter “risk impact investigation”, content that may be needed for carrying out the recall investigation may be those related to the risk associated with the recall of the headache medicine. This may include content related to revenue loss, recall cost, legal liabilities associated with the recall of the headache medicine, or the like. Likewise, for the assessment parameter “health hazard investigation”, the content that may be needed for the recall investigation may be those related to the health hazards associated with the headache medicine. This may include content related to product description, identification of hazards, such as chemical hazards, biological hazards, physical hazards, exposure assessment, or the like.

As may be gathered from the above, corresponding to each of the assessment parameters, specific content may be required to make an informed decision about whether a recall is necessary and, if so, how it should be executed. The comprehensive nature of these assessment parameters ensures that all aspects of the potential recall are thoroughly examined before a decision regarding the recall of the batches with the anomalies is made.

To extract the content corresponding to the assessment parameters associated with recall investigation, data pertaining to the lifecycle of the batches of the product that have been identified to have the anomalies may be accessed. Data related to the lifecycle of the batches of the product is generally stored in various data management systems (DMSs) of the manufacturer, such as Laboratory Information Management System (LIMS), Risk Management System (RMS), Quality Management System (QMS), Manufacturing Execution System (MES), Enterprise Resource Planning (ERP), etc. These DMSs collectively store and manage various aspects of data related to the lifecycle of the batches of the product, from development and production to distribution and post-market surveillance.

Currently, to access the content corresponding the lifecycle of the product that may be relevant for the recall investigation from the DMSs, a user of the recall decision sub-system is given rights to configure objects or models within the recall decision sub-system by defining their structure, data types and also by mapping the fields for these models to models in the DMSs of the manufacturer like LIMS, RMS, QMS, MES, ERP etc. For example, a user may define a model for “Product” with fields like product name, product code, batch number, etc., and map these fields to corresponding fields in the QMS or the ERP.

Once the recall decision sub-system knows the model definitions, the user defines the duration of the data pull, meaning that the content within the recall decision sub-system is only from last “x” number of years or months from the DMSs, such as the QMS. For example, for retrieving content corresponding to the assessment parameter “quality impact” for investigation of the headache medicine, the user may specify a data pull duration of the last 5 years. This may limit the data retrieval to quality-related information for the batches of the headache medicine mg manufactured within that time frame.

Thereafter, an extract, transform, load (ETL) job is kicked from the recall decision sub-system to extract this data. Once the required data is extracted, as a part of the ETL job, data mining techniques like K-means clustering, histogram analysis, box plots, local outliers factors etc. may be used to determine the outliers or irregularities in the data extracted from the DMSs. This may enable investigation team to determine by closely examining the factors that may affect the decision to recall the batches of the product. For example, the data mining techniques may reveal a pattern of increased customer complaints for a specific batch of the product, indicating a potential quality issue.

However, such a method of accessing the content relating to the lifecycle of the batches of the product from the DMSs that may be relevant for the recall investigation report is not efficient as it requires a lot of manual effort. The process of configuring models, mapping fields, and defining data pull durations is time-consuming and prone to human error. Moreover, this approach may not capture all relevant content, especially if the content is stored in unstructured formats in the DMSs or not directly mapped to the fields of the models of the recall decision sub-system.

Furthermore, this method of accessing the content from the DMSs lacks the ability to automatically identify and retrieve the most relevant information for specific recall investigation assessment parameters. The manual nature of the process may lead to delays in decision-making during critical recall situations, thereby increasing risks to consumer safety and the reputation of the manufacturer.

It is known that in regulated industries, such as pharmaceuticals, medical devices, food production, and similar sectors, manufacturers are required to furnish comprehensive information related to the lifecycle of their products as part of product quality review (PQR) reports. The PQR reports encompass a wide range of information related to the lifecycle of all batches of the product produced in a year, typically organized into distinct chapters. Each chapter may correspond to a specific quality parameter or aspect of the product and is created by accessing and analysing data from the various DMSs used by the manufacturer, as explained previously. For example, one chapter may focus on manufacturing processes, including contents related to production yields, in-process controls, and any significant changes or deviations in manufacturing methods. Another chapter may be dedicated to deviations and non-conformances, including contents relating to any instances where the product or process fell outside of established specifications and the corrective actions taken. Yet another chapter may cover stability test results, providing content on how quality characteristics of the product change over time under various storage conditions.

The content of the chapters of the PQR reports often closely align with the content that corresponds to the assessment parameters required for carrying out the recall investigations for the batches of the product reported to have an anomaly. For example, a chapter on “deviations and non-conformances” in a PQR report may include content that may be relevant for the assessment parameter “quality impact investigation” in a recall investigation. Similarly, the “stability data” chapter of the PQR report may be relevant for the “health hazard investigation” assessment parameter, for example, by providing content on how the efficacy or safety of the product may change over time.

Despite this alignment, generally available recall management systems lack the capability to directly access and utilize the contents already compiled in the PQR reports for the recall investigations. Instead, when a recall investigation is initiated, a separate process is employed to access the same or similar data from the DMSs. This approach results in a duplication of efforts: one set of efforts goes into preparing and maintaining the PQR reports, and another set goes into accessing and compiling similar data for the assessment parameters for carrying out the recall investigations.

This redundancy not only increases the workload but also introduces the risk of inconsistencies between the data in the PQR reports, and the data used for the recall investigations. Furthermore, it extends the time required to gather necessary information for the recall decisions, thereby delaying critical safety-related actions.

Therefore, there is a need for a technique that may leverage existing PQR reports to directly access relevant content for the recall investigation reports, thereby eliminating the redundancy of accessing and processing the same information twice, once for preparing the PQR reports and again for preparing the recall investigation reports. The new technique should be able to navigate the complex structure of the PQR reports, understanding the context and relevance of the content in different chapters, and mapping the content accurately to corresponding recall investigation assessment parameters.

To this end, the present subject matter describes techniques for correlating content of chapters of product quality review (PQR) reports with content corresponding to assessment parameters for the recall investigation reports. The present subject matter addresses limitations of the conventional recall management systems by optimizing the generation of the recall investigation reports based on the content included in the chapters of the PQR reports, thereby improving efficiency and accuracy in product recall processes.

The present subject matter includes obtaining data corresponding to quality events reported in respect of a product. The quality events data may be indicative of deviation of at least one predefined quality parameter of the product with respect to a predefined threshold. Further, one or more assessment parameters that may be required for compiling a recall investigation report for assessing the deviation may be defined.

Furthermore, a PQR report for the product may be accessed from a database associated with a quality management system (QMS). The PQR report may include a plurality of chapters, with each chapter pertaining to a predefined quality parameter of the product. For example, in a pharmaceutical context, one chapter may focus on critical quality attributes, while another chapter may address deviations and non-conformances.

Further, the present subject matter employs a large language model (LLM) to analyse the plurality of chapters of the PQR report. This analysis aims to identify one or more chapters from amongst the plurality of chapters of the PQR report that include content that may correspond to content required in respect of the assessment parameters of the recall investigation report.

The present subject matter further include applying a filter to extract content from the identified relevant chapters of the PQR report corresponding to specific batches associated with quality event deviations. Furthermore, the recall investigation report may be populated with the extracted content, ensuring that the recall investigation report contains all necessary information for assessing the deviation.

Thus, by leveraging the content from relevant chapters of the PQR report of the product, the present subject matter significantly reduces the manual effort required in generating the recall investigation report. This is achieved by automatically accessing and extracting the content from the PQR report that corresponds to the defined assessment parameters for the recall investigation, thereby streamlining the process and improving efficiency in recall management.

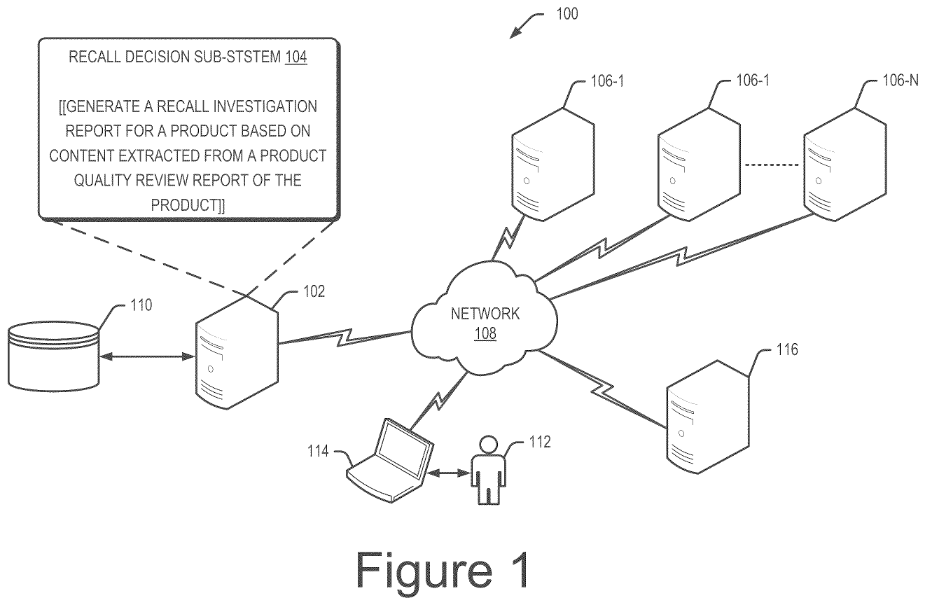

The above techniques are further described with reference to FIG. 1 to FIG. 9. It should be noted that the description and the Figures merely illustrate the principles of the present invention along with examples described herein and should not be construed as a limitation to the present invention. It is thus understood that various arrangements may be devised that, although not explicitly described or shown herein, embody the principles of the present invention. Moreover, all statements herein reciting principles, aspects, and implementations of the present invention, as well as specific examples thereof, are intended to encompass equivalents thereof.

FIG. 1 illustrates a network environment 100 for implementing example techniques for generation of a recall investigation report that may be used for investigating deviations in predefined quality parameters of a product or batches of the product, in accordance with an example implementation of the present subject matter.

When a product or batches of the product are identified to exhibit an anomaly, for example, due to a deviation in one or more predefined quality parameters of the product with respect to a predefined threshold, a recall investigation may need to be conducted to assess the deviation and compile the recall investigation report. The recall investigation may be understood as a systematic examination of factors related to the product to determine the cause of the deviation in the predefined quality parameters, which led to the anomaly, as well as the impact of this deviation. Based on the findings, the recall investigation may lead to recall of the product, which involves the removal of the affected product or the batches of the product from use or distribution to prevent harm and ensure compliance with safety and quality standards as well as regulatory requirements.

Generating the recall investigation report often requires defining assessment parameters based on which the recall investigation may be conducted. For example, when conducting a recall investigation for batches of a pharmaceutical product, such as a headache medicine, the assessment parameters may include “quality investigation”, “health hazard analysis”, “compliance investigation”, and “risk investigation”, among others. These assessment parameters help structure the investigation by focusing on key aspects such as the nature and severity of the deviation, potential health risks, impact of the recall, regulatory compliance, and overall product safety.

Furthermore, for a recall investigation team to effectively assess the deviation based on the defined assessment parameters, relevant content regarding the product corresponding to each assessment parameter may need to be included in the recall investigation report. For example, under the “quality investigation” assessment parameter, content pertaining to batch manufacturing records, test results, and deviations from standard specifications may be included. Similarly, under the “health hazard analysis” assessment parameter, content related to potential adverse effects, toxicology reports, and consumer complaints may be included.

The process of including the content corresponding to each of the assessment parameters typically involves gathering and analyzing information related to the lifecycle of the product, which is stored by the manufacturer in various document management systems (DMSs). These DMSs may contain a wide range of documents and data relating to the lifecycle of the product, including, but not limited to, batch records, analytical test results, equipment logs, stability study reports, supplier information, regulatory correspondence, and other relevant documentation. Another approach to including the content corresponding to the assessment parameters of the recall investigation report may be to determine a correlation between chapters of a product quality review (PQR) report of the product and assessment parameters of the recall investigation report and extract relevant content from the chapters of the PQR report that aligns with the content requirements of the assessment parameters of the recall investigation report.

The advantage of including content in the recall investigation report from the PQR report is that, in some situations, the contents of the chapters of the PQR report align with the content required in respect of the assessment parameters of the recall investigation report. Therefore, instead of retrieving the same content separately from the DMSs, directly accessing and utilizing the content already compiled in the PQR report for recall investigations may help eliminate duplication of effort. Additionally, this approach may reduce workload and minimize the risk of inconsistencies between the content in the PQR report and the content used for the recall investigation. By ensuring that the same validated and consolidated content is used across both reports, the recall investigation process may be made more efficient, accurate, and reliable.

Accordingly, in example implementations of the present subject matter, the network environment 100 may include a product recall management system (PRMS) 102, which may be implemented to generate the recall investigation report. The PRMS 102 may utilize the content from the chapters of the PQR of the product to populate the recall investigation report of the product. By leveraging the content available in the PQR report, the PRMS 102 may streamline the recall investigation process, ensuring accuracy, consistency, and efficiency in compiling the necessary content for evaluating deviations and determining appropriate recall actions. In an example, the PRMS 102 may be implemented and operated by a manufacturer of products to manage workflow relating to recall of the products manufactured by the manufacturer.

In an embodiment, the PRMS 102 may include two primary sub-systems: a recall decision sub-system 104 and a recall execution sub-system (not illustrated in FIG. 1). The recall decision sub-system may serve as a central repository for all information pertinent to the product or batches of the product that may be subject to a recall. In an example, the product may belong to one or more categories. For example, the product categories may include medical devices, pharmaceutical compositions, food, cosmetics of various types, or the like. In an example, the recall decision sub-system 104 may provide workflows for implementing processes for collection, updating, and maintenance of information related to the product, which may be a prerequisite for any activities to be undertaken in respect of the recall of the product, such as generation of the recall investigation report. On the other hand, the recall execution sub-system may implement processes for the execution of the recall.

Although, in FIG. 1, the generation of the recall investigation report is shown to be a functionality of the recall decision sub-system 104, in an alternative embodiment, a separate sub-system may be implemented in the PRMS 102 to generate the recall investigation report for the product. For example, a dedicated recall investigation sub-system may be designed within the PRMS 102 to specifically handle the collection, analysis, and organization of content relevant to the recall investigation. This recall investigation sub-system may access PQR reports to automatically extract and populate relevant content from the PQR reports into the recall investigation report. In some implementations, the recall investigation sub-system may also work independently of the other two sub-systems of the PRMS 102. For example, in cases where the recall investigation is to be done outside the PRMS 102, such as based on a directive from an investor or quality inspector of the product or in response to newly discovered information not yet within the scope of the PRMS 102, the recall investigation sub-system may be implemented as an entity separate from the PRMS 102.

In an embodiment, the network environment 100 may include one or more quality events monitoring systems (QEMSs) 106-1, 106-2, . . . , and 106-N that may be configured to collect data corresponding to quality events reported in respect of the product. In an example, the quality events data may be indicative of deviation in one or more of the predefined quality parameters of the product with respect to a predefined threshold. In an example, the QEMSs 106-1, 106-2, . . . , and 106-N may collect the quality events data continuously or at predefined intervals, depending on the specific requirements and capabilities of the QEMSs 106-1, 106-2, . . . , and 106-N. In an example, the QEMSs 106-1, 106-2, . . . , and 106-N may gather the quality events data from various sources such as production lines, laboratory test results, and customer complaints. Therefore, the QEMSs 106-1, 106-2, . . . , and 106-N may serve as a centralized data collection point, aggregating the quality events data from various systems of records of the manufacturer, such as manufacturing systems, quality control databases, and supply chain management systems.

In an embodiment, the quality events data collected by the QEMSs 106-1, 106-2, . . . , and 106-N may be accessed by the PRMS 102, for example, over a network 108, and stored in a PRMS database 110. In an example, the PRMS database 110 may be implemented and maintained by the manufacturer of the product to serve as a comprehensive repository for storing and managing various types of product-related information. In an example, the PRMS database 110 may be updated periodically with the updated quality events data. This periodic updating may involve incorporating new quality events data, revising existing records, and archiving outdated information, for example. In an example, the frequency of updates may vary depending on factors such as the criticality of the product, regulatory requirements, the volume of data generated, and the quality management policies of the manufacturer.

Though not shown in the example implementation depicted in FIG. 1, the PRMS database 110 may reside within the PRMS 102. Thus, example implementations where the quality events data resides in a memory of the PRMS 102 are possible. Likewise, example implementations where the quality events data is in an external database accessible by the PRMS 102 are also possible. The external database may be accessed by the PRMS 102 through the network 108.

In an example, the network 108 may be a single network or a combination of multiple networks and may use a variety of different communication protocols. The network 108 may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NON), Public Switched Telephone Network (PSTN). Depending on the technology, the network 108 includes various network entities, such as gateways, and routers; however, such details have been omitted for the sake of brevity of the present description.

In an embodiment, based on the quality events data, the recall decision sub-system 104 may identify one or more batches of the product for which deviation in the predefined quality parameters have been recorded and that require further investigation to assess the deviation. In an example, this identification process may involve analyzing various parameters, which may include, but are not limited to, magnitude of deviation, duration of deviation, frequency of deviation, criticality of the affected parameter, cumulative effect of multiple minor deviations, trend analysis, production conditions, raw material variability, environmental factors, and regulatory thresholds.

In an example, the recall decision sub-system 104 may use predefined rules, statistical methods, and/or machine learning algorithms to evaluate these parameters and flag batches of the product that exceed predetermined thresholds or exhibit concerning patterns. For example, in the case of a headache medicine, the recall decision sub-system 104 may identify batches 1, 3, 9, and 80 as requiring further investigation due to deviations in active ingredient concentration, dissolution rate, or the presence of unexpected impurities. These batches may have shown variations that, while not necessarily outside regulatory limits, exhibit patterns or trends that warrant closer examination to ensure product safety and efficacy. By considering this comprehensive set of parameters, the recall decision sub-system 104 may effectively identify batches of the product that have an anomaly, and the recall investigation may be launched for those specific batches.

Once the batches of the product in respect of which the recall investigation is to be conducted are identified, a representative 112 of the manufacturer may initiate the process to generate the recall investigation report for the identified batches of the product. In an embodiment, the recall decision sub-system 104 of the PRMS 102 may incorporate mechanisms for receiving a request for conducting investigation regarding the batches of the product identified to have the anomaly and generation of the recall investigation report from the representative 112 of the manufacturer. In an example, the request for generating the recall investigation report may be entered into the recall decision sub-system 104 by the representative 112 of the manufacturer via a user device 114. Examples of the user device 114 may include, but are not limited to, a desktop computer, a laptop, a tablet, a smartphone, or any other suitable computing device capable of connecting to the network 108 and communicating with the recall decision sub-system 104.

In an example, the recall decision sub-system 104 may be accessible on the user device 114 over the network 108 to receive the request for the generation of the recall investigation report. For example, the recall decision sub-system 104 may provide a user interface, for example, a webpage or an electronic form that may be accessed by the representative 112 of the manufacturer, for example, through the user device 114, to issue the request for the generation of the recall investigation report to the PRMS 102.

In some embodiments, the PRMS 102 may be available locally on the user device 114, allowing for offline functionality and data synchronization when connectivity to the network 108 is established. The PRMS 102 may utilize various communication channels, such as email, SMS, or a dedicated portal, to receive the request for the generation of the recall investigation report. In some examples, an action notification to generate the recall investigation report may be automatically created in the recall decision sub-system 104 of the PRMS 102 upon identification of the batches of the product that have an anomaly based on the quality events data.

Once the request regarding the generation of the recall investigation report for the batches of the product that are identified to have the anomaly is received at the recall decision sub-system 104, the assessment parameters that may be required for compiling the recall investigation report in respect of the identified batches of the product may be defined. As explained previously, the assessment parameters may be understood as specific criteria or aspects of the product and its manufacturing process that need to be evaluated during the recall investigation.

In an embodiment, once the assessment parameters required for compiling the recall investigation report in respect of the identified batches of the product is defined, the recall decision sub-system 104 may initiate a workflow to obtain relevant content corresponding to the assessment parameters of the recall investigation report.

Accordingly, in an embodiment, the recall decision sub-system 104 may access a quality management system (QMS) 116, for example, over the network 108, to retrieve the PQR report of the product. In an example, the QMS 116 may be implemented and operated by the manufacturer of the product. In an example, the QMS 116 may implement one or more workflows to manage the lifecycle of the product. The QMS 116 may also implement workflows for generation of the PQR report of the product. For example, the QMS 102 may implement workflows for collection of content required to be included in the chapters of the PQR report, generation of the PQR report, review processes, and approval procedures related to the PQR report. In an embodiment, data generated by the QMS 116 at each of the stages of the generation of the PQR report may be stored in a QMS database (not illustrated). The QMS database may be structured to facilitate efficient retrieval and analysis of data, for example, from one or more DMSs of the manufacturer of the product, for generation of the PQR report of the product and review purposes. The QMS database also stores the PQR report generated by the QMS 116.

As may be understood, the generation of the PQR report for a product, either annually or biannually, is a regulatory requirement that needs be complied with by the manufacturer. The PQR report may include one or more chapters. Each chapter may include a title corresponding to predefined quality parameters of all batches of the product. For example, if a chapter is to include content related to stability studies of the batches of the product, then the chapter may be named “stability studies”. Each chapter may include content pertaining to a predefined quality parameter of the batches of the product. The content within each chapter may be structured to provide information about the respective quality parameter. This may include quantitative data, qualitative assessments, historical trends, and comparative analyses. For example, the manufacturing process review chapter may contain content related to batch records, equipment logs, and process validation data. The chapter related to the quality control test results may include analytical data, stability studies, and out-of-specification investigations. This comprehensive PQR report helps ensure consistency in product quality, facilitates trend analysis, and supports compliance with regulatory standards. By maintaining a detailed record of batch-wise quality performance, the PQR report serves as a valuable resource for quality assurance, risk assessment, and recall investigations when necessary.

In an embodiment, once the PQR report is accessed from the QMS database, the recall decision sub-system 104 may use a large language model (LLM) to identify a chapter of the PQR report that contains content with at least a preset degree of semantic similarity to one or more assessment parameters defined for the recall investigation report. Once a chapter of the PQR report is identified as meeting the preset similarity threshold with a specific assessment parameter, the recall decision sub-system 104 may apply a filter to the identified chapter to extract content relevant to the batches of the product associated with the deviation. The recall decision sub-system 104 may then populate the recall investigation report with the content corresponding to the assessment parameters that is extracted from the PQR report. For example, if the chapter “investigation” in the PQR report is identified as having the preset degree of similarity with the assessment parameter “quality investigation” of the recall investigation report, the recall decision sub-system 104 may apply a filter to this chapter of the PQR report to extract content relevant to the batches of the product associated with the deviation. The recall decision sub-system 104 may then populate the content corresponding to the assessment parameter “quality investigation” in the recall investigation report using the extracted content.

Accordingly, by leveraging LLM-based content analysis and filtering, the present subject matter ensures that relevant, batch-specific information is efficiently retrieved from the PQR report and incorporated into the recall investigation report, reducing manual effort and improving accuracy in recall decision-making.

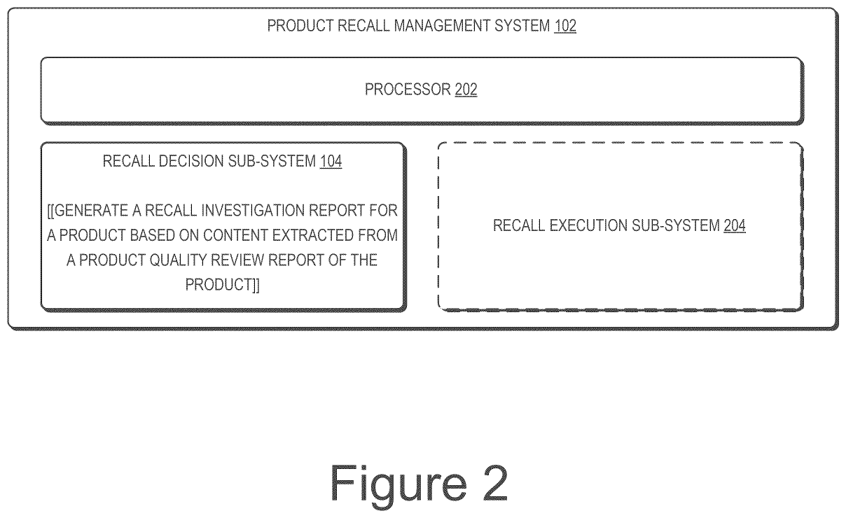

FIG. 2 illustrates a block diagram of the PRMS 102, in accordance with an example implementation of the present subject matter.

In an example, the PRMS 102 may be one or more computing devices, such as desktop computers, laptops, smartphones, personal digital assistants (PDAs), tablets, and servers.

As explained previously, product recalls are implemented across various industries to ensure consumer safety and regulatory compliance. The PRMS 102 is a tool designed to streamline the recall process for a product, or batches of the product found to have an anomaly or non-compliant with the regulatory requirements. The PRMS 102 may facilitate efficient decision-making regarding whether a recall is necessary and, if so, manages the execution of the recall process. The PRMS 102 helps manufacturers and regulators to effectively identify, track, and address potential safety issues, ensuring timely and appropriate responses to product concerns.

As explained previously, the PRMS 102 includes two sub-systems, namely, the recall decision sub-system 104 and the recall execution sub-system 204 each coupled to a processor 202 of the PRMS 102. In an example, the processor 202 may be implemented as microprocessors, microcomputers, microcontrollers, digital signal processors, central processing units, state machines, logic circuitries, and/or any devices that manipulate signals based on operational instructions. The processor 202 may execute instructions stored in a memory of the PRMS 102 to accomplish functionalities of the PRMS 102.

As explained previously, the recall decision sub-system 104 aids in determining whether a recall is necessary. This determination may be made, for example, based on an investigation regarding a deviation in at least one predefined quality parameter of the product with respect to a predefined threshold. Once a decision regarding the recall has been made, the recall execution subsystem 204 manages the process of implementing the recall. In an example implementation, these sub-systems may be provided independently. For instance, a manufacturer of a pharmaceutical product may already have a recall decision-making process in place but lacks a system for efficiently executing recalls across multiple healthcare providers and facilities. In this case, the manufacturer may implement only the recall execution sub-system 204 to enhance their ability to quickly and effectively manage the logistics of recalling pharmaceutical products once a recall decision has been made. Conversely, a medical equipment manufacturer may have a predefined recall execution process in place but may not have an established process for determining when a recall is necessary. For example, the recall decision-making of the medical equipment manufacturer may rely on the investigation of data from post-market surveillance, but the medical equipment manufacturer may lack a structured system to analyze this data effectively. In such a scenario, the medical equipment manufacturer may choose to implement only the recall decision sub-system 104 to improve their ability to investigate data and make timely, informed decisions about recalls for their medical devices.

In accordance with an example implementation of the present subject matter, the recall decision sub-system 104 may be used to conduct investigation into deviation in the predefined quality parameters of the product with respect to the predefined threshold so as to make decision regarding the recall of the product identified to have deviated from the predefined quality parameters.

In doing so, in an embodiment, recall decision sub-system 104 may obtain data, for example, from the one or more QEMSs 106-1, 106-2, . . . , and 106-N, corresponding to the quality events reported in respect of the product. As explained previously, the quality events data may be indicative of the deviation in one or more of the predefined quality parameter of the product with respect to a predefined threshold. In an embodiment, the assessment parameters necessary for compiling the recall investigation report for assessing the deviation in respect of the product may be defined, for example, based on the input from the representative 112 of the manufacturer of the product.

In an embodiment, having been provide the assessment parameters for generating the recall investigation report by a user, the recall decision sub-system 104 may access the PQR report of the product, for example, from the QMS database of the QMS 116. As explained previously, the PQR report of the product may include multiple chapters, each corresponding to one of the predefined quality parameters of the batches of the product and containing content related to that specific quality parameter. For example, a chapter in the PQR report may correspond to the predefined quality parameter “stability testing” and include content on the stability performance of different batches of the product over time, such as environmental conditions, degradation trends, and compliance with stability specifications. Similarly, another chapter may be related to “deviation management” and include records of deviations observed during manufacturing or testing, investigations conducted, and corrective or preventive actions taken.

In an embodiment, having accessed the PQR report, the recall decision sub-system 104 may use the LLM to identify a chapter in the PQR report that contains content with at least a preset degree of semantic similarity to one or more assessment parameters of the recall investigation report.

In an embodiment, after identifying the relevant chapter, the recall decision sub-system 104 may apply a filter to extract content from the chapter that corresponds to the batches of the product associated with the deviation. The recall decision sub-system 104 may then use the extracted content corresponding to the assessment parameters to populate the recall investigation report, ensuring that batch-specific and relevant information is accurately incorporated into the recall investigation process. For example, the recall decision sub-system 104 may use the LLM to analyze the PQR report and identify a chapter titled “deviations and non-conformances” as having the preset degree of semantic similarity with the assessment parameter “compliance investigation” in the recall investigation report. Based on this similarity, the recall decision sub-system 104 may apply a filter to the content of the “deviations and non-conformances” chapter to extract relevant content specific to the batches of the product that have been identified as deviating from predefined quality parameters. In that, if multiple batches of a pharmaceutical product failed dissolution testing beyond the allowable threshold, the “deviations and non-conformances” chapter in the PQR report may include details such as deviation reports, root cause analyses, corrective and preventive actions (CAPAs) taken, and regulatory impact assessments. The recall decision sub-system 104, using the LLM, may filter this chapter to extract deviation records related to the affected batches and populate the recall investigation report in respect of the “compliance investigation” assessment parameter with relevant findings.

Thus, by using the content of the chapters of the PQR report to populate the recall investigation report, the present subject matter ensures that the time taken to extract content for the recall investigation report from various DMSs is significantly reduced. Additionally, it minimizes duplication of effort by directly utilizing the structured and precompiled information available in the PQR report. This approach not only enhances efficiency of the recall investigation but also reduces the risk of inconsistencies between data extracted from different sources. By leveraging predefined content from the PQR report, the recall decision sub-system 104 may ensure that the recall investigation report is generated more accurately, consistently, and in compliance with regulatory requirements, thereby improving the overall recall management process.

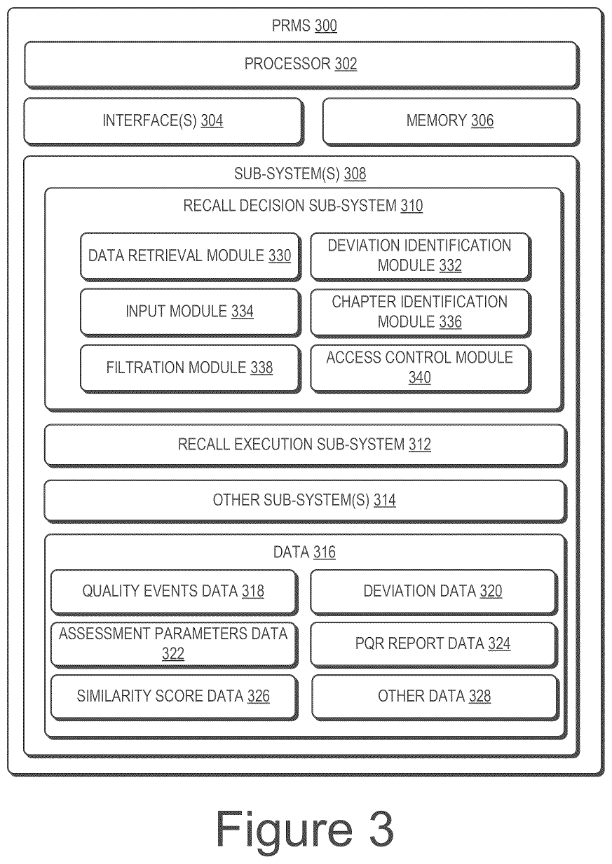

To elaborate on the functionality of the PRMS 102 to generate the recall investigation report for a product or batches of the product based on the content of the PQR report, reference is made to FIG. 3.

FIG. 3 illustrates the PRMS 300 that optimizes the process of generation of the recall investigation report for a product or batches of products, in accordance with another example implementation of the present subject matter.

In an example, the PRMS 300 is similar to the PRMS 102, as explained in reference to FIGS. 1 and 2. In an example, the PRMS 300 depicted in FIG. 3 may be any computing device. Examples of the PRMS 300 may include but are not limited to servers, desktop computers, laptops, smartphones, personal digital assistants (PDAs), and tablets.

In an embodiment, the PRMS 300 may include a processor 302. In an example, the processor 302 may be implemented as microprocessors, microcomputers, microcontrollers, digital signal processors, central processing units, state machines, logic circuitries, and/or any devices that manipulate signals based on operational instructions. The PRMS 300 may also include interface(s) 304. The interface(s) 304 may include a variety of software and hardware interfaces that allow interaction of the QMS 102 with other communication and computing devices, such as network entities, web servers, external repositories, and peripheral devices, such as input/output (I/O) devices. For example, the interface(s) 304 may couple the PRMS 300 with the QEMSs 106-1, 106-2, . . . , and 106-N, the QMS 116, and the user device 114 of the representative 112 of the manufacturer. The interface(s) 304 may also enable coupling of internal components, if any, of the PRMS 300 with each other.

Further, in an embodiment, the PRMS 300 may include a memory 306 coupled to the processor 302. The memory 306 may include any computer-readable medium known in the art including, for example, volatile memory (e.g., RAM), and/or non-volatile memory (e.g., EPROM, flash memory, etc.). The memory 306 may also be an external memory unit, such as a flash drive, a compact disk drive, an external hard disk drive, or the like.

The PRMS 300 may include sub-system(s) 308 and data 316 coupled to the processor 302. In one example, the sub-system(s) 308 and a data 316 may reside in the memory 306. The sub-system(s) 308 may be implemented as a combination of hardware and programming, for example, programmable instructions to implement a variety of functionalities of the sub-system(s) 308. In examples described herein, such combinations of hardware and programming may be implemented in several different ways. For example, the programming for the sub-system(s) 308 may be executable instructions. Such instructions in turn may be stored on a non-transitory machine-readable storage medium which may be coupled either directly with the PRMS 300 or indirectly (for example, through networked means). In an example, the sub-system(s) 308 may include a processing resource of their own, for example, either a single processor or a combination of multiple processors, to execute such instructions. In the present examples, the processor-readable storage medium may store instructions that, when executed by the processor 302, implement the functionalities of the sub-system(s) 308. In other examples, the sub-system(s) 308 may be implemented as electronic circuitry.

In an embodiment, the sub-system(s) 308 may include a recall decision sub-system 310, a recall execution sub-system 312, and other sub-system(s) 314. In an example, the recall decision sub-system 310 and the recall execution sub-system 312 are similar to the recall decision sub-system 104 and the recall execution sub-system 204, respectively, explained in reference to FIGS. 1 and 2. The other subsystem(s) 314 may further implement functionalities that supplement applications or functions performed by the PRMS 300 or any of the sub-system(s) 308 of the PRMS 300. The data 316, on the other hand, includes data that is either stored or generated as a result of functionalities implemented by the PRMS 300 or any of the sub-system(s) 308. It may be further noted that information stored and available in the data 316 may be utilized by the sub-system(s) 308 for generating the recall investigation report for a product or batches of the product.

In an embodiment, the data 316 may include quality events data 318, deviation data 320, assessment parameters data 322, PQR report data 324, similarity score data 326, and other data 328. The data 316 serves, amongst other things, as a repository for storing data that may be fetched, processed, received, or generated by one or more of the sub-system(s) 308.

The recall decision sub-system 310 may be configured to generate the recall investigation report in respect of a product or batches of the product. This recall investigation report may be relied upon to decide whether to recall the product or specific batches of the product from the market. The recall investigation report may include comprehensive data and analysis related to quality events, deviations from predefined quality parameters, and potential risks associated with the product. The information included in the recall investigation report may be crucial for stakeholders to make informed decisions regarding product recalls, ensuring consumer safety and regulatory compliance. Also, the recall investigation report may go back to data generated during the manufacturing/packaging/distribution lifecycle of the product to see what went wrong that lead to deviation in the quality parameters of the product.

As explained previously, the need for a recall investigation typically arises when one or more batches of the product deviate from their predefined quality parameters. Such deviations may occur due to various factors, including manufacturing errors, contamination, component degradation, packaging defects, labeling errors, or unexpected adverse effects reported by consumers. When these deviations are detected or reported, the recall investigation report serves as a critical tool to assess the severity, scope, and potential impact of the issues within the product. Therefore, to generate the recall investigation report for the product, it may be necessary to identify the batches of the product that have deviated from the predefined quality parameters.

Accordingly, a data retrieval module 330 of the recall decision sub-system 310 may access the QEMSs 106-1, 106-2, . . . and 106-N, for example, over the network 108, to obtain data corresponding to the quality events reported in respect of the product. For the purposes of the present description, any reference made to a product for which a recall investigation report is to be generated may encompass a single product, a specific set or batch of the product, or multiple sets or batches of the product that have been manufactured by the manufacturer for distribution and use by end consumers. For example, the product may refer to a particular medication with a specific dosage and formulation, such as “pain relief tablets 500 mg.” In this context, the recall investigation may focus on a single production batch (e.g., batch A12345), multiple batches produced within a certain timeframe (e.g., all batches manufactured in Q3 2023), or the entire product line across various manufacturing facilities.

As explained previously, the quality events may be indicative of deviation in at least one predefined quality parameter of the product with respect to a predefined threshold. For example, a quality event may be reported when a batch of pharmaceutical tablets shows a dissolution rate outside the acceptable range, or when microbial count of a food product exceeds safety limits. These deviations from predefined quality parameters may trigger a need for a thorough investigation to determine the extent of the issue and potential risks to consumers and whether deviation in the quality parameter warrants a recall of the product.

As explained previously, the QEMSs 106-1, 106-2, . . . and 106-N may refer specialized software platforms managed by the manufacturer of the product. The QEMSs 106-1, 106-2, . . . and 106-N may be designed to collect, track, and manage data related to quality events throughout the product lifecycle. In an example, the QEMSs 106-1, 106-2, . . . and 106-N may collect quality events data in respect of the product through various means, including, but not limited to, automated data capture from manufacturing equipment, manual input by quality assurance personnel, integration with laboratory systems, customer feedback, routine quality control tests, or the like.

In some embodiments, the PRMS 102 may also collect data in relation to the quality events in respect of the product, either in addition to or instead of the QEMSs 106-1, 106-2, . . . , and 106-N. In an example, the PRMS 102 may have direct connections to the production systems, quality control laboratories, and customer service platforms for gathering the quality events data, that may include, but is not limited to, data corresponding to manufacturing deviations, out-of-specification test results, batch failures, customer complaints, adverse event reports, stability testing outcomes, and packaging or labeling issues.

In an example, the data corresponding to the quality events that is accessed by the data retrieval module 330 may be stored in the data 316 as the quality events data 318.

In an embodiment, a deviation identification module 332 of the recall decision sub-system 310 may use the quality events data 318 to identify the batches of the product whose predefined quality parameters have deviated from the predefined threshold. In an example, to identify such batches of the product, the deviation identification module 332 may conduct data mining on the quality events data 318 to detect any instances where measured quality parameters fall outside the acceptable ranges defined for the product. This, for example, may involve comparing recorded values for parameters such as potency, purity, or physical characteristics against their respective predefined thresholds.

In an example, the deviation identification module 332 may also consider the frequency and severity of deviations, flagging batches that show consistent or significant departures from expected quality standards. Additionally, the deviation identification module 332 may utilize statistical analysis techniques to identify trends or patterns in the quality data that could indicate systemic issues affecting multiple batches or production runs. For example, the deviation identification module 332 may analyze the quality events data from multiple batches of a headache medicine and identify batches 1, 3, 9, and 80 as having products with anomalies that require further investigation. These anomalies may be related to deviations in dissolution rates, active ingredient concentration, or the presence of unexpected impurities in the headache medicine. The deviation identification module may flag these batches 1, 3, 9, and 80 for a more in-depth investigation to determine the root cause of the anomalies and ascertain whether a recall is warranted for such batches.

In an example, data corresponding to the identified batches of the product with the anomalies identified for further investigation may be stored in the data 316 as the deviation data 320.

In some embodiments, identification of the batches of the product with the anomalies may be done outside the PRMS 102 and the data corresponding to the identified batches of the product with the anomalies may be accessed by the recall decision sub-system 310, for example, over the network 108, for the recall investigation. For example, the QEMSs 106-1, 106-2, . . . and 106-N may monitor predefined quality parameters of the batches of the product and automatically flag any deviations that exceed specified thresholds. In an example, the QEMSs 106-1, 106-2, . . . and 106-N may be configured to detect the anomalies such as out-of-specification test results, unexpected impurities, or deviations in physical properties of the product. When such anomalies are detected, the QEMSs 106-1, 106-2, . . . and 106-N may generate alerts and compile relevant data, including batch numbers, specific quality parameters that deviated, and the extent of the deviation. This information may then be transmitted to the PRMS 102, where the information may be accessed by the recall decision sub-system 310 for further analysis and recall investigation.

Once the batches of the product that have the anomalies are identified, the process to generate the recall investigation report containing investigation regarding the identified batches of the product may be initiated. In an embodiment, to initiate the process of generating the recall investigation report, a representative, such as the representative 112, of the manufacturer may enter a request, for example, through the user device 114, at the recall decision sub-system 310 through an input module 334 of the recall decision sub-system 310. For example, the representative 112 may access a secure web portal provided by the input module 334, where the representative 112 may submit the request to initiate the recall investigation process. Upon submission, the request is logged in the recall decision sub-system 310, triggering automated notifications to relevant stakeholders and initiating the predefined workflow for recall investigation. In an example, the representative 112 may be a quality assurance manager, regulatory affairs specialist, or other designated personnel responsible for product safety and compliance.

In an embodiment, an access control module 340 of the recall decision sub-system 310 may be configured to control access of the recall decision sub-system 310, to users, such as the representative 112 of the manufacturer, based on predefined authorization rules. In doing so, to allow the representative 112 to enter the request regarding generating of the recall investigation report, the access control module 340 may verify authorization of the representative 112. In an example, this authorization process may involve verifying credentials of the representative 112, such as a unique username and password, or employing multi-factor authentication methods. The access control module 340 may cross-reference the provided credentials against a database of authorized users that may be stored in the PRMS database 110. In an example, if the authorization is successful, the representative 112 is granted access to the necessary forms or interfaces to submit the recall investigation request.

In some embodiments, a project for creating the recall investigation report may be created automatically at the recall decision sub-system 310 even without request from the representative 112, such as when the recall decision sub-system 310 is configured to automatically initiate the workflows for the recall investigation regarding the batches of the product identified to have the anomalies. For example, the recall decision sub-system 310 may be integrated with the QEMSs 106-1, 106-2, . . . and 106-N to receive real-time data on the quality events. When the recall decision sub-system 310 detects that certain predefined thresholds for quality parameters deviations are exceeded in specific batches of the product, the recall decision sub-system 310 may automatically trigger the creation of a recall investigation project for the identified batches of the product.

Once the request for generating the recall investigation report for the identified batches is received at the recall decision sub-system 310, there may be a need to define the assessment parameters based on which the recall investigation may be conducted, and the recall investigation report may be generated. These assessment parameters may be understood as criteria or areas of focus based on which the recall investigation for the batches of the product identified to have the anomalies may be conducted.

In an example, the assessment parameters may include, but are not limited to, the “quality investigation”, “health hazard analysis”, “compliance investigation”, “risk investigation”, or the like. These assessment parameters may serve as a framework for systematically analyzing the identified batches of the product to determine the root cause of the quality issue, assess the potential impact on product safety and efficacy, and guide decision-making regarding the scope and urgency of the recall of the identified faulty batches of the product. These assessment parameters thus ensure a comprehensive evaluation of all relevant aspects, from manufacturing processes to potential consumer risks, allowing for a thorough and structured approach to the recall investigation process.

In an embodiment, the assessment parameters for the recall investigation process may be defined by users with specific expertise in relevant areas. For example, based on the type of the product and the deviation in the predefined quality parameters of the identified batches of the product, a quality assurance manager may define the “quality investigation” as an assessment parameter that may cover investigation regarding aspects like product composition analysis and manufacturing process evaluation. Similarly, a toxicologist or medical expert may define the “health hazard analysis” as an assessment parameter to investigate potential adverse effects and population risk stratification. A regulatory affairs specialist may specify the “compliance investigation” as an assessment parameter to address GMP adherence and documentation review. Additionally, a risk management professional may define the “risk investigation” as an assessment parameter to assess the probability of harm and develop risk mitigation strategies.

In an embodiment, the recall decision sub-system 310 of the PRMS 102 may incorporate mechanisms for receiving inputs, from the users authorized to work on the recall investigation report, regarding the assessment parameters to be included in the recall investigation report that are necessary for conducting investigation regarding the batches of the product identified to have the anomalies. In an example, the input for defining the assessment parameters for generating the recall investigation report may be entered into the recall decision sub-system 310, through the input module 334, by the users authorized by the manufacturer via the user device 114. In an example, these authorized users may include quality assurance managers, regulatory affairs specialists, toxicologists, and risk management professionals, each contributing their expertise to define relevant assessment parameters. The input module 334 may provide a structured interface allowing these users to specify and customize assessment parameters based on the specific nature of the product and the identified anomalies.

In some embodiments, the assessment parameters necessary for conducting the recall investigation may be created automatically once the input for generation of the recall investigation report is received at the recall decision sub-system 310, for example, based on predefined rules such as the type of the product, type of the deviation, and other relevant factors. Upon receiving the input, for example, either automatically based on detection of the batches of the product that have the anomaly or based on the input from the representative 112 of the manufacturer, the recall decision sub-system 310 may access a database of predefined rules and analyze specific details including product type, deviation type, severity, applicable regulatory requirements, and historical data from similar cases of the deviation. Based on this analysis, the recall decision sub-system 310 may automatically generate a set of tailored assessment parameters. For example, a pharmaceutical product with a potential contamination issue may include assessment parameters such as batch “purity analysis” and “sterility testing”, while a medical device with a potential malfunction may include the assessment parameters, such as failure mode analysis and performance testing. The automatically generated assessment parameters may then be presented to a user authorized to handle respective aspect of the investigation for review, approval, and modification, ensuring a comprehensive and appropriate set of assessment parameters for the recall investigation. In an example, the recall decision sub-system 310, may also incorporate machine learning algorithms to continuously improve the accuracy and relevance of automatically generated assessment parameters based on feedback from authorized users and outcomes of previous recall investigations.

In an embodiment, along with regarding assessment parameters to be included in the recall investigation report, the users authorized to work on the recall investigation may also include a textual description in respect of each assessment parameter. In an example, the textual description may be indicative of a purpose of the corresponding assessment parameter. For example, for the assessment parameter “quality investigation,” a textual description may state: “this covers product composition analysis, manufacturing process evaluation, and batch consistency.” For the assessment parameter “health hazard analysis,” the textual description may be: “evaluate potential adverse health effects, including deaths, injuries, and side effects from product use.” Similarly, for assessment parameter “compliance investigation”, the textual description may read: “focus on GMP adherence, regulatory reporting, and documentation completeness.” Likewise, for the assessment parameter “risk investigation,” a textual description may state: “assess probability and severity of harm, develop risk profile, and recommend mitigation strategies.” In an example, the textual description provided in respect of each assessment parameter may be used to access the content from the PQR report for the assessment parameters, for example, by matching the textual description against the chapters of the PQR report.

In an example, inputs corresponding to the assessment parameters received from the users authorized to work on the recall investigation report may be stored in the database 316 as the assessment parameters data 322.

In an example, based on the assessment parameters defined for the recall investigation report by the users, a template for the recall investigation report may be generated, for example, by the input module 334 of the recall decision sub-system 310. In an example, the template may define a layout for the recall investigation report, including sections corresponding to each defined assessment parameter. In an example, the layout may indicate or arrange the assessment parameters in the recall investigation report, for example, based on priority of the assessment parameters in determination of decision of the recall. The template may include standardized headings, subheadings, and placeholders for specific information related to each assessment parameter, structured to reflect this priority-based arrangement. The template of the recall investigation report thus serves as a structured framework, ensuring that all necessary content corresponding to the assessment parameters is systematically documented.

Once the assessment parameters for the recall investigation report are defined and the layout of the recall investigation report is generated, the content corresponding to the assessment parameters that may be required for the completion of the recall investigation may be obtained and included in the recall investigation report in respect of the corresponding assessment parameters.

Accordingly, in an embodiment, a chapter identification module 336 of the recall decision sub-system 310 may access the QMS database of the QMS 116 to retrieve the PQR report of the product. As explained previously, the PQR report is generated for all the batches of the product manufactured for a predetermined period of time and, by applying a filter for the batches that are identified to have the anomalies, relevant information specific to these batches may be extracted from the PQR report.

In an embodiment, the chapter identification module 336 may identify, using the LLM, a chapter of the PQR report with content that has the preset degree of semantic similarity with the one or more assessment parameters of the recall investigation report. In an example, to identify the chapter of the PQR report with the content that has the preset degree of semantic similarity with the assessment parameters, the chapter identification module 336 may access the textual description of the user associated with each of the assessment parameters. In an example, the textual description may be indicative of a purpose of the assessment parameter and, as explained previously, may be provided by the user of the respective assessment parameter. In an example, the chapter identification module 336 may compare the textual description with a description of each chapter of the PQR report. In an example, the description of the chapter of the PQR report may be indicative of the purpose of the chapter of the PQR report. For example, a textual description for the “quality investigation” assessment parameter may state “evaluate manufacturing process deviations and quality control test results,” while a chapter of the PQR report may have a description reading “analysis of batch manufacturing processes and quality control outcomes.”

Further, in an example, the chapter identification module 336 may determine, using the LLM, a similarity score between the textual description and the description of the chapter. In an example, the similarity score may be indicative of a degree to which the purpose of the assessment parameter aligns with the purpose of the chapter. Furthermore, in an example, the chapter identification module 336 may identify a chapter from the chapters of the PQR report with a similarity score exceeding a predetermined threshold as the chapter that meets the preset degree of semantic similarity with the assessment parameter. For example, if the similarity score between the textual description associated with the assessment parameter “quality investigation” and description of the PQR report as mentioned above exceeds a threshold of 0.8 (on a scale of 0 to 1), that chapter may be identified as semantically similar to the assessment parameter. This process ensures that the most relevant chapters of the PQR report are accurately matched to the corresponding assessment parameters, facilitating efficient and targeted content retrieval for the recall investigation.

In an embodiment, once the PQR report chapters corresponding to the assessment parameters of the recall investigation report are identified, a filtration module 338 of the recall decision sub-system 310 may apply a filter to extract the content specific to the batches identified with anomalies. For example, in case of the headache medicine with affected batches 1, 3, 9, and 80, the filtration module 338 may retrieve relevant content from the identified chapters of the PQR report only for the batches 1, 3, 9, and 80. In an example, the content extracted may be those related to manufacturing parameters, quality control results, packaging details, and batch-specific graphs and charts for the “quality investigation” assessment parameter, as well as revenue loss projections, legal liabilities, health hazard assessments, and risk characterization data for the “risk impact analysis” assessment parameter. In an example, the filtration module 338 may employ structured query language (SQL) queries or application programming interface (API) calls to access this information from the QMS database containing the content of the chapters of the PQR report or external business intelligence (BI) tools, applying filters (e.g., WHERE batch_id IN (1, 3, 9, 80)) to ensure only the content pertinent to the affected batches is extracted. In an example, the filtration module 338 may be capable of handling various data formats, including, but not limited to, text, tables, graphs, and charts, ensuring comprehensive information retrieval from the PQR report for the specific batches under investigation.

The approach of accessing the content from the PQR reports for the recall investigation assessment parameters reduces investigation time, ensures data consistency, and enables targeted analysis by fetching specific batch-related content. This automated process minimizes human error, allows for rapid scaling across multiple products or batches, and enhances the accuracy and efficiency of the recall investigations.

In an embodiment, the filtration module 338 may prompt respective users of the assessment parameters to verify the extracted content from the chapters of the PQR report prior to including the content in respective assessment parameters. This verification step may allow the users to review and validate the extracted content, ensuring its relevance and accuracy for the specific recall investigation. The users may have the option to accept, reject, or modify the extracted content before it is incorporated into the assessment parameters of the recall investigation report, thereby enhancing the overall quality and reliability of the recall investigation process.

In an embodiment, based on the verification from the users, the extracted content may be populated into the recall investigation report in respect of the corresponding assessment parameters by the filtration module 338. Based on the content corresponding to the assessment parameters of the recall investigation report, a recall investigation may be conducted to ascertain the root cause of the deviation, the extent of the deviation, potential health and safety risks, and the necessary corrective actions. This investigation may involve analyzing the populated content from the PQR report alongside additional information specific to the affected batches. The comprehensive assessment enables quality managers and investigators to make informed decisions regarding the scope of the recall, the urgency of the situation, and the appropriate mitigation strategies to implement. By leveraging the pre-populated, validated content from the PQR report for the recall investigation report, the recall investigation process may be made more efficient, thorough, and data-driven, leading to faster resolution of the quality issues and improved product safety measures.

In an embodiment, the access control module 340 may be configured to manage and restrict access to the content of the chapters of the PQR report, ensuring that only authorized users of the recall investigation report may retrieve the relevant content, based on predefined authorization rules. Accordingly, in an embodiment, before extracting the content from the chapters of the PQR report, the access control module 340 may verify whether the users accessing the content from the chapters of the PQR report also have the necessary permissions to access the respective content from the DMSs. If the access control module 340 confirms that a user has the required access rights to retrieve the content both from the PQR report and the DMSs, the access control module 340 may then authorize the extraction of the relevant content in accordance with the defined assessment parameters of the recall investigation report. This ensures data security, compliance with access policies, and controlled dissemination of sensitive information within the recall investigation process.

In an embodiment, the deviation identification module 332 may be configured to analyze the content of the chapters of the PQR report and identify one or more batches of the product with recurring deviation in the at least one predefined quality parameter of the product with respect to the predefined threshold. Based in this identification, the deviation identification module 332 may send a notification to the recall decision sub-system 310 to generate the recall investigation report in respect of the one or more batches of the product. This may allow for identifying the batches of the product that may later exhibit anomalies and may be required to be recall. Identifying the batches of the product that may later be subject to recall during the preparation of the PQR report may be crucial for proactive recall management and supply chain control. Instead of waiting for a deviation or compliance issue to trigger a recall investigation, early identification may allow the manufacturers to take preventive actions such as halting distribution, adjusting production processes, or conducting internal audits. If potential quality concerns, such as stability failures or microbial contamination, are detected during the PQR preparation, the manufacturers may intervene before the product reaches the market, reducing the risk of costly recalls. If a manufacturer of the product already knows which quality parameters are critical for recalls (e.g., stability failures, out-of-specification results, or contamination reports), linking these quality parameters to the PQR report generation process and the recall investigation may ensure continuous monitoring.

For example, if a QMS, such as the QMS 116, that is used for preparing the PQR report, detects an increasing trend of microbial contamination in recent batches of the product during preparation of the PQR report of the product, the QMS 116 may immediately notify the recall decision sub-system 310, prompting an investigation regarding the contamination before the distribution of the product in the market. Similarly, if data meant for inclusion in the PQR report reveals that multiple batches of a pain-relief medication exhibit dissolution failures under specific humidity conditions, the manufacturer may take corrective actions such as halting shipments to humid regions, initiating additional stability testing, or modifying storage conditions before product release. By embedding recall-related monitoring within the PQR report preparation process, the manufacturer may anticipate potential batch failures, send alerts to recall decision sub-system 310 ahead of time for conducting the investigation regarding the identified batches, and even prevent the need for full-scale recalls, leading to better compliance, cost savings, and enhanced consumer safety.

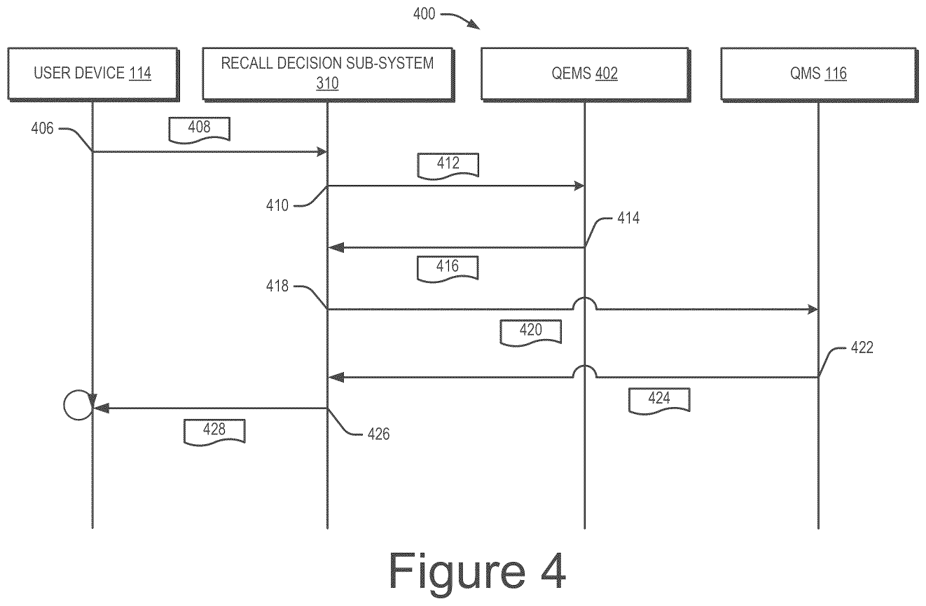

FIG. 4 illustrates a signal flow 400 in a process to generate a recall investigation report for the batches of the product identified to the anomalies, according to an example implementation of the present subject matter.

As described with reference to FIGS. 1-3, upon identifying a deviation in one or more predefined quality parameters in a product or its batches that may cause anomalies in the product, there may be a need to conduct a recall investigation to ascertain the nature, impact, and scope of the deviation. In this respect, a recall investigation report may be generated, which includes assessment parameters containing content to be used for the investigation. These assessment parameters may encompass data such as deviation details, root cause analysis, risk assessment, compliance evaluation, and corrective or preventive actions. The recall investigation report serves as a critical document during the recall investigation process, helping to determine whether a recall of the affected batches is required based on the severity of the anomalies and their potential impact on product quality, safety, and regulatory compliance.

As explained previously, the recall decision sub-system 310 may provide a mechanism to correlate the content required in respect of the assessment parameters of the recall investigation report with the content included in the chapters of the PQR report of the product. The recall decision sub-system 310 may then filter the content based on its relevance and make the content available in respect of the corresponding assessment parameters of the recall investigation report. By including the content corresponding to the assessment parameters of the recall investigation report by extracting the content from the PQR report, the present subject matter allows for significantly reducing the manual effort required for data collection from the DMSs, validation, and compilation of the recall investigation report.

In an example implementation of the present subject matter, as indicated in step 406, an instruction 408 to monitor the quality events in respect of a product may be received at the recall decision sub-system 310, for example, from the representative 112 of the manufacturer of the product. In an example, the recall decision sub-system 310 may be accessible to the representative 112 on the user device 114 allowing the representative 112 to issue the instruction 408.

In an embodiment, upon receiving the instructions 408, the recall decision sub-system 310 may need to obtain quality events data related to the product, for example, to identify any deviation in the predefined quality parameters of the product that could necessitate a recall investigation. To achieve this, in an embodiment, as indicated in step 410, the recall decision sub-system 310 may send a first access request 412, for example, over the network 106, to a quality events monitoring system (QEMS) 402 to retrieve the quality events data associated with the product. In an example, the QEMS 402 may be similar to the QEMS 106-1, 106-2, . . . 106-N, as explained in reference to FIGS. 1-3. As previously described, the quality events data may indicate deviations in at least one predefined quality parameter of the product relative to a predefined threshold, which could signal potential non-conformities or risks requiring further investigation.

In an embodiment, as indicated in step 414, the quality events data 416 corresponding to the product may be received at the recall decision sub-system 310 from the QEMS 402. Upon receiving this data, the recall decision sub-system 310 may analyze the quality events data 416 to identify batches of the product exhibiting anomalies, for example, due to deviations in one or more quality parameters, that may require further investigation prior to making decision regarding there recall of such batches.

In an embodiment, once the batches of the product for which the recall investigation is to be conducted are identified, the assessment parameters required for compiling the recall investigation report to assess the deviation may be defined. As explained previously, the assessment parameters may be factors based on which the recall investigation is performed to determine the cause, impact, and extent of the deviation in the predefined quality parameters of the product. These assessment parameters may include, but are not limited to, quality investigation, compliance evaluation, health hazard analysis, and risk assessment. For example, if a pharmaceutical product batch exhibits an out-of-specification (OOS) result for dissolution testing, the assessment parameters may include an investigation into manufacturing processes, stability studies, raw material quality, and historical batch performance. By defining these parameters, the recall decision sub-system 310 ensures a structured approach to evaluating the deviation, facilitating a comprehensive recall investigation and informed decision-making regarding the recall actions.

Further, in an embodiment, as indicated in step 418, the recall decision sub-system 310 may send a second access request 420 to the QMS 116 to access the PQR report of the product. As explained previously, the PQR report may include the chapters. Each chapter may correspond to one of the predefined quality parameters of a plurality of batches of the product and include contents related to that quality parameter.

In an embodiment, as indicated in step 422, a confirmation message 424 regarding the granting of access to the PQR report of the product may be received at the recall decision sub-system 310. Once access to the PQR report is established, the recall decision sub-system 310 may proceed to identify, using the LLM, a chapter of the PQR report containing content that has at least a preset degree of semantic similarity with one or more assessment parameters defined for the recall investigation report. In an embodiment, the recall decision sub-system 310 may then apply a filter to the identified chapter to extract content relevant to the batches of the product associated with the deviation. For example, if the assessment parameter “compliance investigation” is defined in the recall investigation report, and the chapter “deviations and non-conformances” in the PQR report is found to have a high degree of semantic similarity, the recall decision sub-system 310 may extract only the content relevant to the affected batches, including figures, charts, and tables from the identified chapter. Once extracted, the content corresponding to the assessment parameters may be populated into the recall investigation report. In an example, based on the content included in the recall investigation report corresponding to the assessment parameters, the recall investigation may be conducted.

In an embodiment, once the generated recall investigation report is reviewed and approved by the users of the recall investigation report, the same may be made accessible to the representative 108 of the manufacturer, for example, on the user device 114 of the representative, as a response data 428, as indicted in step 426.

Accordingly, the present subject matter facilitates the retrieval of relevant content from the PQR report and leverages this content to populate the recall investigation report corresponding to the respective assessment parameters. Accessing the content for the recall investigation report from the PQR report contributes to saving time required for accessing the content from the DMSs, thereby not only accelerating the recall investigations but also improving compliance and decision-making by ensuring that the recall investigation report is generated with precise and relevant information.

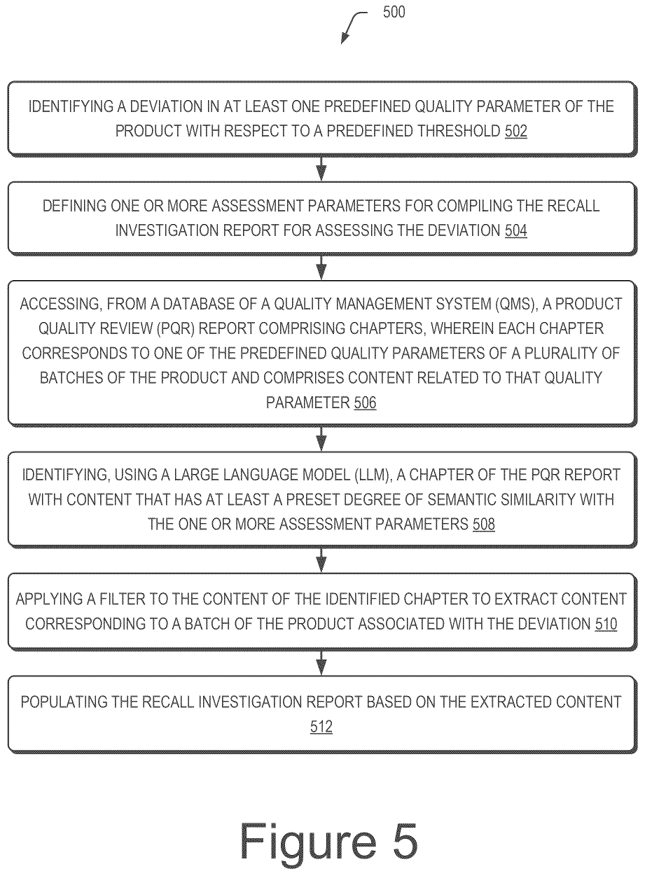

FIG. 5 illustrates a method 500 for generation of a recall investigation report of a product or batches of the product that are identified to have deviated from a predefined quality parameters leading to anomies in the product, according to an example implementation of the present subject matter. Although the method 500 may be implemented in a variety of computer-based systems, for ease of explanation, the present description of the example method 500 for the generation of the recall investigation report for the product is provided in reference to the above-described recall decision sub-system 104, 310.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof. The steps of the method 500 as well as other methods described herein may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned method.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 502, the method 500 may include identifying a deviation in a predefined quality parameter of the product with respect to a predefined threshold. As explained previously, the deviation in the predefined quality parameter of the product may be identified by the deviation identification module 332 based on the quality events data reported in respect of the product.

At block 504, the method 500 may include defining one or more assessment parameters for compiling the recall investigation report for assessing the deviation. As explained previously, the assessment parameters may be specific criteria or metrics that may be used to evaluate the deviations in the predefined quality parameters of the product. These assessment parameters help determine the extent, impact, and risks associated with the recall of the product with the anomalies. In an example, the assessment parameters may be defined based on the input received from the users authorized to prepare the recall investigation report.

At block 506, the method 500 may include accessing, from a database, such as the QMS database of the QMS 116, a PQR report. As explained previously, the PQR report, that may be accessed by the data retrieval module 330, may include a plurality of chapters. In an example, each chapter may corresponds to one of the predefined quality parameters of a plurality of batches of the product and include content related to that quality parameter.

At block 508, the method 500 may include, identifying a chapter of the PQR report that include content that has at least a preset degree of semantic similarity with the one or more assessment parameters defined for the recall investigation report. In an example, the chapter identification module 336 may use a large language model to identify the chapter that includes the content that has the preset degree of semantic similarity with the one or more assessment parameters.

At block 510, the method 500 may include applying a filter to the content of the identified chapter to extract content corresponding the assessment parameters in respect of the batches of the product that are associated with the deviation. In an example, the filtration module 338 may apply the filter to the content of the chapter of the PQR report identified to be relevant in respect of the one or more of the assessment parameters and extract only the content that is pertinent for inclusion in the recall investigation report in respect of the defined assessment parameters of the recall investigation report. This ensures that only batch-specific, relevant information is included in the report, thereby enhancing the accuracy and efficiency of the recall investigation process.

At block 512, the method 500 may include populating the recall investigation report based on the extracted content. In an example, the filtration module 338 may populate the extracted content into the relevant sections of the recall investigation report in respect of the assessment parameters for which the chapter, including the identified relevant content, is selected.

Thus, by reusing the content of the chapters from the PQR report in the generation of the recall investigation report, the example method 500 enables minimizing the time required for conducting the investigations into deviations in the defined quality parameters of the product, thereby enhancing the overall effectiveness of recall investigations.

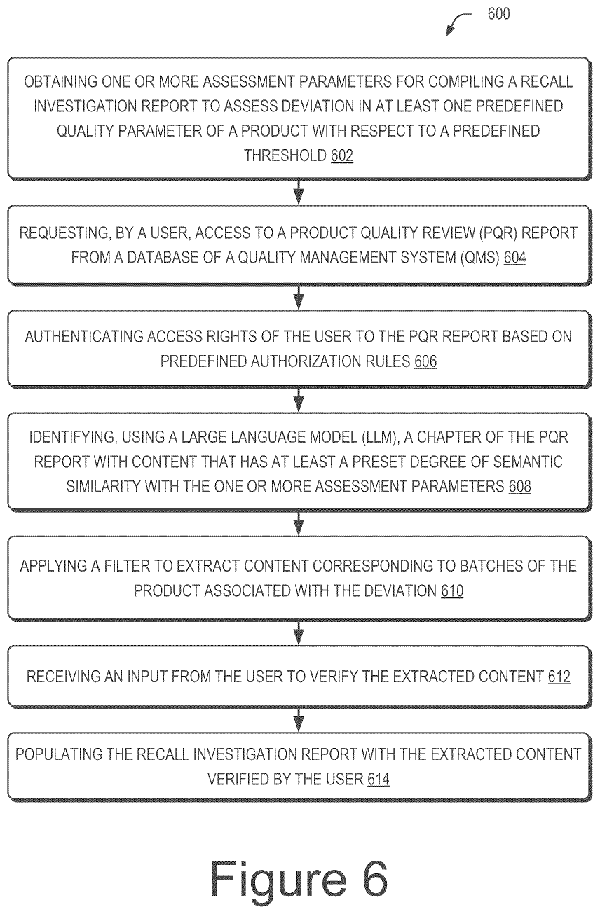

FIG. 6 illustrates a flow diagram of a process 600 for generating a recall investigation report in respect of a product or batches of product that are identified to the have the anomalies, according to an example implementation of the present subject matter. The order in which the above-mentioned process is described is not intended to be construed as a limitation, and some of the described process blocks may be combined in a different order to implement the process or an alternative process.

Furthermore, the above-mentioned process 600 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 600 may be implemented by the above-described recall decision sub-system 104, 310.

Referring to FIG. 6, at block 602, the process 600 may include obtaining one or more assessment parameters for compiling the recall investigation report to assess the deviation in at least one predefined quality parameter of the product with respect to a predefined threshold. As explained previously, the assessment parameters may define the key factors for investigating the deviation, such as quality investigation, compliance assessment, health hazard analysis, and risk evaluation. In an example, the assessment parameters on which the recall investigation report is to be compiled may be provided by users assigned to investigate the deviation, such as quality assurance specialists, compliance officers, or regulatory experts.

At block 604, the process 600 may include requesting, by a user, access to a PQR report from a database of a quality management system (QMS), such as the QMS 116. As explained previously, the PQR report may contain structured data about quality lifecycle of the product, including batch records, stability studies, deviation reports, and corrective and preventive actions (CAPAs), among others. In an example, the process 600 described in block 604 is similar to the step described at block 506 of method 500, where access to the PQR report is essential to extract content relevant to the identified deviations.

At block 606, the process 600 may include authenticating the access rights of the user to the PQR report based on predefined authorization rules. In an example, the access control module 340 may verify whether the user has the necessary permissions to view and extract content from the PQR report, ensuring data security and compliance with internal and regulatory policies. In an example, the user accessing the PQR report may be an authorized investigator, quality manager, or regulatory affairs officer who requires the content of the PQR report to populate the recall investigation report in respect of the corresponding assessment parameters of the recall investigation report. If the access rights of the user are validated, the process proceeds to the next step of retrieving relevant content from the PQR report.

At block 608, the process 600 may include identifying, using the LLM, a chapter of the PQR report that contains content with at least a preset degree of semantic similarity to one or more assessment parameters defined for the recall investigation report. In an example, the LLM of the chapter identification module 336 may analyze the textual content of the chapters of the PQR report and compare it with the assessment parameters to determine the relevant chapters corresponding to the assessment parameters. In an example, if one of the assessment parameters in the recall investigation report is “compliance investigation”, the LLM may identify a chapter in the PQR report, such as “deviations and non-conformances”, that discusses instances where the product failed to meet predefined quality specifications, as the relevant chapter corresponding to the assessment parameter “compliance investigation”.

At block 610, the process 600 may include applying a filter to extract content from the identified chapter of the PQR report. In an example, the filtration module 338 may select the content of the relevant that corresponds to the batches of the product associated with the deviation in relation to the assessment parameters of the recall investigation report. For example, if the “deviations and non-Conformances” chapter of the PQR report has been identified as relevant to the “compliance investigation” assessment parameter, the filtration module 338 may extract content only for the batches of the product where non-conformances were detected. This may include specific deviation records, corrective and preventive actions (CAPA), root cause analysis findings, and any impact assessments conducted for those batches.

At block 612, the process 600 may include receiving user input to verify the extracted content before the content is included in the recall investigation report. In an example, the user, who may be responsible for handling the assessment parameter in respect of which the content is extracted, may review the extracted content and provide feedback, such as confirming its relevance, refining specific details, or requesting additional data. The input may also include modifications to the extracted content to ensure that the recall investigation report accurately reflects the investigation findings and complies with regulatory or organizational requirements.

At block 614, the process 600 may include populating the recall investigation report with the verified and, if necessary, modified extracted content. In an example, the user may make edits, additions, or deletions to ensure clarity, completeness, and consistency with the investigation objectives. The recall investigation report may be dynamically updated based on the received edits, ensuring that the final version contains the most accurate and relevant information. For example, if the extracted content from the “deviations and non-conformances” chapter of the PQR report includes batch deviations related to out-of-specification (OOS) test results, the user may choose to include only the most critical deviations that directly impact product quality and exclude minor discrepancies deemed insignificant. Once reviewed and finalized, the updated recall investigation report may serve as the official document for determining recall actions, ensuring compliance, and maintaining auditability.

Thus, using the content of the PQR report to populate the recall investigation report may help reduce the manual effort required in compiling the recall investigation report, and improve accuracy in recall assessments.

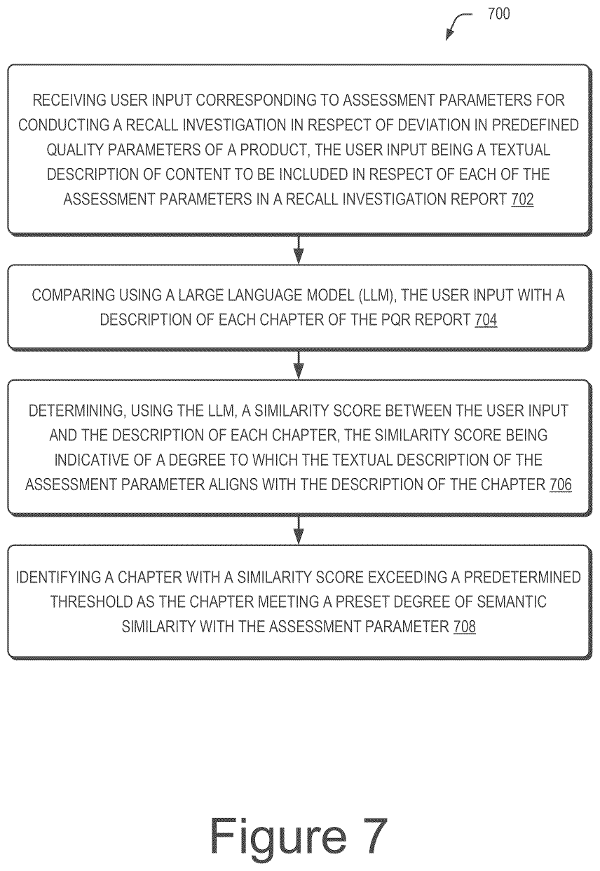

FIG. 7 depicts a flow diagram of a process 700 for identifying a chapter of the PQR report with content that has at least a preset degree of semantic similarity with the one or more assessment parameters defined for the recall investigation report, in accordance with an example implementation of the present subject matter. The order in which the above-mentioned process 700 is described is not intended to be construed as a limitation, and some of the described process blocks may be combined in a different order to implement the process, or an alternative process.

Furthermore, the above-mentioned process 700 may be implemented in a suitable hardware, computer-readable instructions, or combination thereof. The steps of such process may be performed by either a system under the instruction of machine executable instructions stored on a non-transitory computer readable medium or by dedicated hardware circuits, microcontrollers, or logic circuits. Herein, some examples are also intended to cover non-transitory computer readable medium, for example, digital data storage media, which are computer readable and encode computer-executable instructions, where the instructions perform some or all the steps of the above-mentioned methods. In an example, the process 700 may be implemented by the above described recall decision sub-system 104, 310.

At block 702, the process 700 may include receiving user input corresponding to the assessment parameters for conducting a recall investigation regarding a deviation in predefined quality parameters of the product. In an example, the user input, that may be provided by the users responsible handling recall investigations, may include a textual description of the content that needs be included in respect of each of the assessment parameters in the recall investigation report.

At block 704, the process 700 may include comparing, for example, using the LLM, the user input corresponding to an assessment parameter with the description of each chapter of the PQR report to determine if any chapter of the PQR report contextually corresponds to the assessment parameter. In an example, the chapter identification module 336 may compare the textual description provided for an assessment parameter, which, for example, may define what the assessment parameter is trying to evaluate in the recall investigation, with the description of each chapter of the PQR report, which, for example, may indicate the type of content included in that chapter.

At block 706, the process 700 may include determining, using the LLM, a similarity score between the user input corresponding to an assessment parameter and the description of each chapter in the PQR report. In an example, the similarity score may indicate the degree of alignment between the textual description of the assessment parameter, which defines what the parameter is trying to evaluate in the recall investigation, and the description of a chapter in the PQR report, which outlines the content included within that chapter.

At block 708, the process 700 may include identifying a chapter of the PQR report with a similarity score exceeding a predetermined threshold as the chapter that meets the preset degree of semantic similarity with the assessment parameter. For example, if the assessment parameter in the recall investigation report is “stability evaluation”, its textual description may state: “This parameter assesses whether stability studies indicate any significant degradation trends in the product that may impact its shelf life, safety, or efficacy.” Meanwhile, a chapter in the PQR report titled “stability testing and trending” may have the description: “This chapter contains stability test results across multiple batches, including long-term and accelerated stability studies, degradation trends, and compliance with stability specifications.” Using the LLM, the chapter identification module 336 may compute a similarity score between the textual description of the assessment parameter and the description of the chapter. If the similarity score exceeds a predefined threshold, such as 0.85 on a scale of 0 to 1, the chapter identification module 336 may identify “stability testing and trending” as the relevant chapter for populating the recall investigation report in respect of the assessment parameter “stability evaluation”.

This automated matching mechanism ensures that the most relevant content from the PQR report is efficiently retrieved for populating the recall investigation report, minimizing the manual effort and enhancing accuracy in compiling the recall investigation report.

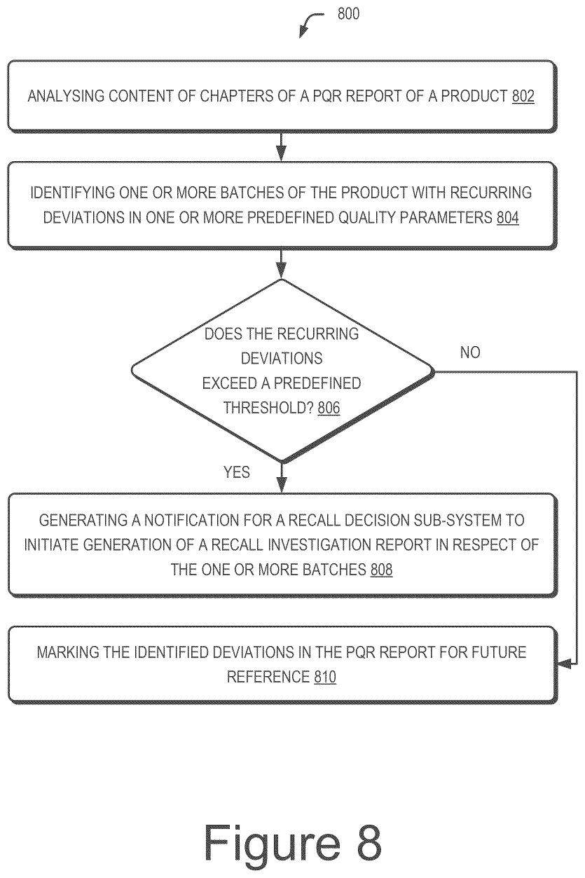

FIG. 8 illustrates a flow diagram of a process 800 for generating a recall investigation request for batches of a product that are identified to have anomalies during generation of a PQR report of the product, according to an example implementation of the present subject matter. The order in which the above-mentioned process is described is not intended to be construed as a limitation, and some of the described process blocks may be combined in a different order to implement the process or an alternative process.

Furthermore, the above-mentioned process 800 may be implemented in suitable hardware, computer-readable instructions, or a combination thereof. The steps of such a process may be performed by either a system under the instruction of machine-executable instructions stored on a non-transitory computer-readable medium or by dedicated hardware circuits, microcontrollers, or logic circuits. Herein, some examples are also intended to cover non-transitory computer-readable medium, for example, digital data storage media, which are computer readable and encode computer-executable instructions, where the instructions perform some or all the steps of the above-mentioned methods. In an example, the process 800 may be implemented by the above-described recall decision sub-system 104, 310.

As explained previously, identifying batches of a product that may be prone to recall during preparation of a PQR report of the product may enable proactive recall management by allowing manufacturers to detect potential quality issues in the batches early. Instead of waiting for deviations to trigger a recall investigation, early identification may help in halting distribution, adjusting production processes, or conducting internal audits, thereby reducing the risk of costly recalls. By developing a connection between the QMS 116, which is responsible for implementing the workflows for the generation of the PQR report, and the recall decision sub-system 310, the data from the PQR report reviews may be directly fed into recall investigation workflows within the recall decision sub-system 310. This may ensure real-time monitoring, quicker decision-making, and enhanced compliance, leading to more efficient recall management and product quality assurance.

Accordingly, in an embodiment, at block 802, the process 800 may include analyzing content of chapters of a PQR report of a product.

At block 804, the process 800 may include identifying one or more batches of the product with recurring deviations in one or more predefined quality parameters.

At block 806, an assessment may be made if the recurring deviations exceed a predefined threshold. For example, if a batch consistently shows out-of-specification results for a quality parameter like stability or microbial contamination, the QMS 116 may flag this as a potential risk that may require a deeper investigation or triggering a recall process based on the severity of the issue. If the deviations surpass the threshold, it may indicate a systemic issue that warrants immediate action. In case the assessment is affirmative, the process 800 may proceed to block 808. At block 608, the process 800 may include generating a notification, for example, by a user of the QMS 116 working on generating the PQR report, for the recall decision sub-system 310 to initiate generation of a recall investigation report in respect of the one or more batches.

However, if at block 806, it is determined that the recurring deviations do not exceed the predefined threshold, the process 800 may proceed to block 810. At block 810, the process 800 may include marking the identified deviations in the PQR report for future reference. For example, the QMS 116 may flag the deviations within the report as “monitoring required,” indicating that although the deviations are currently within acceptable limits, they may need to be reviewed again in future reports or during subsequent production cycles. This ensures that potential issues in the batches of the product are tracked and may be revisited if trends develop over time or if new data suggests a need for further investigation.

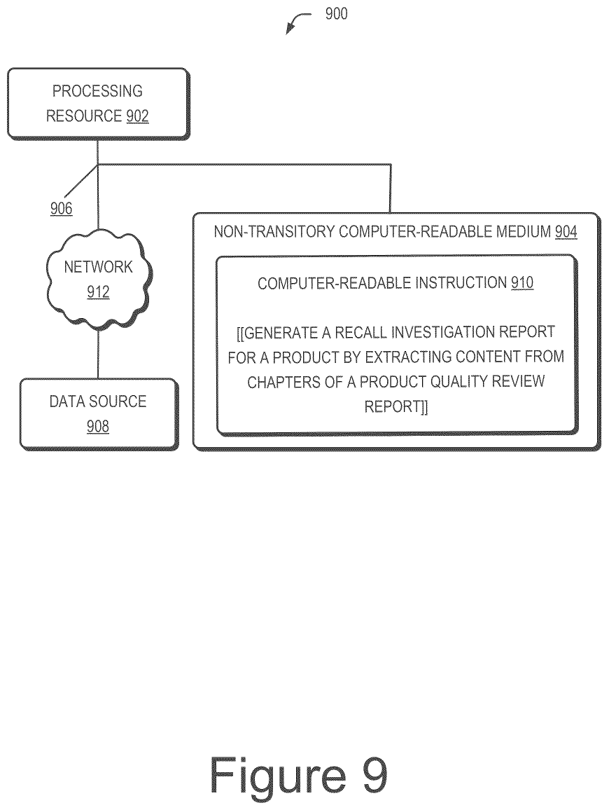

FIG. 9 illustrates a computing environment 900 for generating a recall investigation report in respect of a product or batches of the product in response to identification of deviations in predefined quality parameters of the product, according to an example implementation of the present subject matter. In an example implementation, the computing environment 900 may include a computing device, such as the above-described recall decision sub-system 104, 310. The computing environment 900 includes a processing resource 902 communicatively coupled to the non-transitory computer-readable medium 904 through a communication link 906.

In an example, the processing resource 902 may be a processor of the computing device, such as the processor 302 of the PRMS 300, 102, that fetches and executes computer-readable instructions from the non-transitory computer-readable medium 904.

The non-transitory computer-readable medium 904 may be, for example, an internal memory device or an external memory device. In an example implementation, the communication link 906 may be a direct communication link, such as any memory read/write interface. In another example implementation, the communication link 906 may be an indirect communication link, such as a network interface. In such a case, the processing resource 902 can access the non-transitory computer-readable medium 904 through a network 912. The network 912 may be a single network or a combination of multiple networks and may use a variety of different communication protocols. The processing resource 902 and the non-transitory computer-readable medium 904 may also be communicatively coupled to data sources 908.

In an example implementation, the non-transitory computer-readable medium 904 includes executable instructions 910 for generating the recall investigation report based on the content of the chapters of the PQR report, thereby reducing the time and effort required for conducting investigations into deviations in the defined quality parameters of the product.

In an embodiment, the instructions 910 may cause the processing resource 902 to obtain quality events data in respect of the product. As explained previously, the quality events data may be indicative of a deviation in at least one quality parameter of the product from a predefined threshold. For example, the quality events data may indicate that the concentration of an active ingredient in a pharmaceutical product has fallen below the acceptable range specified in quality standards of the product. In an example, this deviation may be identified through routine quality control testing or as a result of customer complaints.

In an embodiment, the instructions 910 may cause the processing resource 902 to obtain user input relating to the deviation. In an example, the user input may be textual description of one or more assessment parameters required for compiling a recall investigation report for assessing the deviation.

In an embodiment, the instructions 910 may cause the processing resource 902 to further access, from a database, such as the QMS database of QMS 116, a PQR report. As explained previously, the PQR report includes a plurality of chapters. Each chapter may correspond to one of the predefined quality parameters of a plurality of batches of the product and includes content related to that quality parameter. For example, a PQR report for a pharmaceutical product may include chapters on “raw material and packaging component review”, “critical process parameter review”, “finished product quality review”, “stability data analysis”, “complaints and adverse event summary”, “deviations and non-conformances”, or the like. Each of these chapters may contain content related to its specific quality parameter, covering data from multiple batches of the product produced over a defined period, typically in a year.

In an embodiment, the processing resource 902 may identify, using a large language model (LLM), a chapter of the PQR report with content that has at least a preset degree of semantic similarity with the user input. Further, in an embodiment, the processing resource 902 may apply a filter to the identified chapter to extract content of the identified chapter corresponding to a batch of the product associated with the deviation. Furthermore, the processing resource 902 may generate the recall investigation report based on the extracted content. For example, if the user input describes a deviation in the dissolution rate of a specific batch of tablets, the LLM may identify the “finished product quality review” chapter of the PQR report as having high semantic similarity. The processing resource 902 may then filter this chapter to extract content specific to the affected batch of the product. This extracted content, which may include historical dissolution data, manufacturing parameters, and any previous investigations related to dissolution issues for that batch, may be used to populate the recall investigation report in respect of the relevant assessment parameters.

In an embodiment, to identify the chapter of the PQR report with the content that has the preset degree of semantic similarity with the user input, the processing resource 902 may compare the user input with a description of each chapter of the PQR report. The processing resource 902 may further determine, using the LLM, a similarity score between the user input and the description of the chapter. In an example, the similarity score may be indicative of a degree to which the textual description of the assessment parameter aligns with the description of the chapter. The processing resource 902 may then identify a chapter with a similarity score exceeding a predetermined threshold as the chapter that meets the preset degree of semantic similarity with the assessment parameter.

In an embodiment, the processing resource 902 may control access to the content of the chapters of the PQR report based on predefined authorization rules to allow only authorized personnel to view and utilize specific content of the PQR report in generation of the recall investigation report. These authorization rules may be based on factors such as job role, department, security clearance level, or specific project assignments. For example, quality assurance personnel may have full access to all the chapters of the PQR report, while production staff may only have access to chapters directly related to manufacturing processes.

In an embodiment, the processing resource 902 may receive user verification of the extracted content from the PQR report, for example, prior to populating the recall investigation report. In an example, the user may be presented with a preview of the extracted information and given options to approve, reject, or modify the content before it is incorporated into the recall investigation report. This human-in-the-loop approach ensures that the automated content extraction process is supervised and validated by subject matter experts, thereby maintaining the integrity and reliability of the final recall investigation report.

In an embodiment, the processing resource 902 may analyze the content of the chapters of the PQR report to identify one or more batches of the product with recurring deviations in at least one predefined quality parameter with respect to the predefined threshold. Upon identifying such batches, the processing resource 902 may send a notification to the recall decision sub-system 310 to generate a recall investigation report for these batches. This allows for early detection of potential quality issues across multiple batches of the product at the PQR report generation stage, enabling timely investigation and corrective actions. This may allow identification of the batches that are still to be sent to market, preventing distribution of substandard products. Furthermore, this approach may help in identifying systemic issues in the manufacturing process, leading to improvements in overall product quality and consistency. The ability to flag recurring deviations across batches may provide valuable insights that may not be apparent when examining individual batch data in isolation, thereby enhancing the effectiveness of quality control measures and reducing the risk of widespread product recalls.

In an embodiment, the processing resource 902 may receive an input from a user to modify the content extracted to be included in the recall investigation report. This may allow for human oversight and expertise to be incorporated into the automated report generation process. The users of the recall investigation report may review the extracted content, make necessary adjustments, add context, or remove irrelevant information before it is finalized in the report. Additionally, the processing resource 902 may update the generated recall investigation report based on received edits from a user. This capability ensures that the final report may be refined and improved even after initial generation, accommodating new insights, additional data, or changes in the scope of the investigation.

Thus, the present subject matter provides for optimizing the process of conducting the recall investigation for the product by allowing generation of the recall investigation report based on the content of the chapters of the PQR report. This provides for reducing time and effort required in compiling relevant information for conducting the recall investigation. This optimization technique enhances the efficiency and accuracy of recall investigations, enabling faster response times to potential quality issues.

Although implementations of this optimization technique have been described in language specific to structural features and/or methods, it is to be understood that the appended claims are not necessarily limited to the specific features or methods described. Rather, the specific features and methods are disclosed as example implementations of an optimized approach for generating the recall investigation reports, ensuring efficiency, accuracy, and compliance with the regulatory requirements.

1. A product recall management system (PRMS), comprising:
a processor configured to:
obtain data corresponding to quality events reported in respect of a product, the quality events data being indicative of deviation in at least one predefined quality parameter of the product with respect to a predefined threshold;
define one or more assessment parameters for compiling a recall investigation report for assessing the deviation;
access, from a database, a product quality review (PQR) report comprising chapters, wherein each chapter corresponds to one of the predefined quality parameters of a plurality of batches of the product and comprises content related to that quality parameter;
identify, using a large language model (LLM), a chapter of the PQR report with content that has at least a preset degree of semantic similarity with the one or more assessment parameters by:
receiving user input corresponding to each of the assessment parameters, the user input being a textual description of the assessment parameter;
comparing the user input with a description of each chapter of the PQR report;
determining, using the LLM, a similarity score between the user input and the description of the chapter, the similarity score being indicative of a degree to which the textual description of the assessment parameter aligns with the description of the chapter; and
identifying a chapter with a similarity score exceeding a predetermined threshold as the chapter that meets the preset degree of semantic similarity with the assessment parameter;
apply a filter to the identified chapter to extract content of the identified chapter corresponding to a batch of the product associated with the deviation; and
generate the recall investigation report with respect to the one or more assessment parameters based on the extracted content.

2. The PRMS of claim 1, wherein the database for accessing the PQR report is a quality management system (QMS) managed by a manufacturer of the product.

3. The PRMS of claim 2, wherein the processor is further configured to control access to the content of the chapters of the PQR report, by one or more users, based on predefined authorization rules.

4. The PRMS of claim 1, wherein the processor is further configured to control access to PRMS by one or more users based on predefined authorization rules.

5. The PRMS of claim 1, wherein the processor is further configured to prompt a user to verify the extracted content from the PQR report.

6. (canceled)

7. The PRMS of claim 1, wherein the processor is further configured to:
analyse the content of the chapters of the PQR report;
identify one or more batches of the product with recurring deviation in the at least one predefined quality parameter of the product with respect to the predefined threshold; and
send a notification to the PRMS to generate a recall investigation report in respect of the one or more batches of the product.

8. A method for generating a recall investigation report for a product, comprising:
identifying a deviation in at least one predefined quality parameter of the product with respect to a predefined threshold;
defining one or more assessment parameters for compiling the recall investigation report for assessing the deviation;
accessing, from a database of a quality management system (QMS), a product quality review (PQR) report comprising chapters, wherein each chapter corresponds to one of the predefined quality parameters of a plurality of batches of the product and comprises content related to that quality parameter;
identifying, using a large language model (LLM), a chapter of the PQR report with content that has at least a preset degree of semantic similarity with the one or more assessment parameters by:
receiving user input corresponding to each of the assessment parameters, the user input being a textual description of the assessment parameter;
comparing the user input with a description of each chapter of the PQR report;
determining, using the LLM, a similarity score between the user input and the description of the chapter, the similarity score being indicative of a degree to which the textual description of the assessment parameter aligns with the description of the chapter; and
identifying a chapter with a similarity score exceeding a predetermined threshold as the chapter that meets the preset degree of semantic similarity with the assessment parameter;
applying a filter to the content of the identified chapter to extract content corresponding to a batch of the product associated with the deviation; and
populating the recall investigation report with respect to the one or more assessment parameters based on the extracted content.

9. The method of claim 8, wherein accessing the PQR report from the database of the QMS comprises authenticating user access to the PQR report based on predefined authorization rules.

10. The method of claim 8, further comprising receiving an input from a user to modify the content extracted to be included in the recall investigation report.

11. (canceled)

12. The method of claim 8, further comprising:
analysing the content of the chapters of the PQR report;
identifying one or more batches of the product with recurring deviation in the at least one predefined quality parameter of the product with respect to the predefined threshold; and
sending a notification to a product recall management system (PRMS) to generate a recall investigation report in respect of the one or more batches of the product.

13. The method of claim 8, further comprising:
receiving edits from a user in respect of the populated recall investigation report; and
updating the recall investigation report based on the received edits.

14. A non-transitory computer-readable medium comprising instructions executable by a processing resource to:
obtain quality events data in respect of a product, the quality events data being indicative of a deviation in at least one quality parameter of the product from a predefined threshold;
obtain user input relating to the deviation, the user input being textual description of one or more assessment parameters required for compiling a recall investigation report for assessing the deviation;
access, from a database of a quality management system (QMS), a product quality review (PQR) report comprising a plurality of chapters, each chapter corresponds to one of the predefined quality parameters of a plurality of batches of the product and comprises content related to that quality parameter;
identify, using a large language model (LLM), a chapter of the PQR report with content that has at least a preset degree of semantic similarity with the user input by:
comparing the user input with a description of each chapter of the PQR report;
determining, using the LLM, a similarity score between the user input and the description of the chapter, the similarity score being indicative of a degree to which the user input aligns with the description of the chapter; and
identifying a chapter with a similarity score exceeding a predetermined threshold as the chapter that meets the preset degree of semantic similarity with the user input;
apply a filter to the identified chapter to extract content of the identified chapter corresponding to a batch of the product associated with the deviation; and
generate the recall investigation report with respect to the one or more assessment parameters based on the extracted content.

15. The non-transitory computer-readable medium of claim 14, further comprising instructions executable by the processing resource to control access to the content of the chapters of the PQR report by users based on predefined authorization rules.

16. The non-transitory computer-readable medium of claim 14, further comprising instructions executable by the processing resource to receive user inputs for verification of the extracted content from the PQR report.

17. (canceled)

18. The non-transitory computer-readable medium of claim 14, further comprising instructions executable by the processing resource to:
analyse the content of the chapters of the PQR report;
identify one or more batches of the product with recurring deviation in the at least one predefined quality parameter of the product with respect to the predefined threshold; and
send a notification to a product recall management system (PRMS) to generate a recall investigation report in respect of the one or more batches of the product.

19. The non-transitory computer-readable medium of claim 14, further comprising instructions executable by the processing resource to receive an input from a user to modify the content extracted to be included in the recall investigation report.

20. The non-transitory computer-readable medium of claim 14, further comprising instructions executable by the processing resource to update the generated recall investigation report based on edits received from a user.

21. The PRMS of claim 1, wherein the processor is further configured to generate the recall investigation report from the PQR report without retrieving content from at least one document management systems (DMSs) of a manufacturer of the product.

22. The PRMS of claim 1, wherein the processor is further configured to, based on the recall investigation report, automatically send a signal to a recall execution sub-system to execute workflows necessary for recalling the identified batches of the product from a market.

23. The PRMS of claim 1, wherein the processor is further configured to, upon identification of one or more batches of the product with recurring deviation in the at least one predefined quality parameter during generation of the PQR report, initiate preventive actions.
